(19) United States
(12) Patent Application Publication
(10) Pub. No.: US 2004/0094986 A1
(43) Pub. Date: May 20, 2004

(54) Motor vehicle dashboard and the like

(76) Inventors: Dag Landvik, Gustavsberg (SE); Jurgen Bruning, Ohrdruf (DE); Eberhard Lang, Heilbronn (DE); Maik Ziegler, Grafenhain (DE); Peter Nystrom, Habo (SE); Mats Karlsson, Getinge (SE)

Correspondence Address: NILS H. LJUNGMAN, NILS H. LJUNGMAN & ASSOCIATES, P.O. BOX 130, GREENSBURG, PA, 15601-0130, US

(21) Appl. No.: 10/634,730

(22) Filed: Aug. 5, 2003

Related U.S. Application Data
(63) Continuation-in-part of application No. PCT/EP02/01236, filed on Feb. 6, 2002.

(30) Foreign Application Priority Data
Feb. 6, 2001 (DE) 101 05 591.9
Dec. 21, 2001 (DE) 101 63 601.6

(51) Int. Cl. B62D 25/14

(52) U.S. Cl. 296/70

(57) ABSTRACT

There is now provided a motor vehicle dashboard for a motor vehicle. The motor vehicle dashboard has a frame structure that can be attached to a motor vehicle body. The dashboard has a first element with a first attachment side and a second attachment side opposite the first attachment side, with the first attachment side of the first element being configured to be adhered to the frame structure. The first element comprises foam. The dashboard has a second element with a first side that is configured to be exposed towards the interior of a motor vehicle, and a second, attachment, side opposite the first side of the second element. The first side of the second element provides a leather-like appearance to the dashboard. The abstract of the disclosure is submitted herewith as required by 37 C.F.R. §1.72(b). As stated in 37 C.F.R. §1.72(b), “A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.” Therefore, the abstract is not intended to limit the claims in any manner and should not be interpreted as limiting the claims in any manner.

### CONTINUING APPLICATION DATA

This application is a Continuation-In-Part application of International Patent Application No. PCT/EP02/01236, filed on Feb. 6, 2002, which claims priority from Federal Republic of Germany Patent Application No. 101 05 591.9, filed on Feb. 6, 2001 and from Federal Republic of Germany Patent Application No. 101 63 601.6, filed on Dec. 21, 2001. International Patent Application No. PCT/EP02/01236 was pending as of the filing date of this application. The United States was an elected state in International Patent Application No. PCT/EP02/01236.

### BACKGROUND OF THE INVENTION

1. Field of the Invention

The invention relates to a motor vehicle dashboard and the like.

2. Background Information

Such motor vehicle dashboards define a shell that is locally provided with openings, and thus serve, in particular, to conceal, in the cavity defined between the front body panel of the vehicle and the shell, numerous housings and/or conduits, capable of supporting the equipment, instruments, and accessories and air conditioning systems and/or electrical systems that are usually provided in the forward, interior region of a motor vehicle.

There may be provided a motor vehicle fascia panel that commonly contains at least one duct for air distribution, which is arranged to be supplied with a stream of processed air that is drawn from a heating and ventilating, and/or air conditioning, apparatus and to deliver this processed air towards outlet ports which are open in selected locations in the interior of a vehicle. Such air outlets normally include deicing vents for deicing and/or demisting the windscreen of the vehicle and, where appropriate, the side windows of the vehicle. The vents may also include ventilators which are disposed on a front part of the fascia panel, and which may consist of side ventilators and at least one central ventilator. Most fascia panels contain a set of ducts, which are generally interposed between the heating and ventilating, and/or air conditioning, apparatus and the various outlet vents.

A dashboard for a motor vehicle may be composed of a base framework which is predetermined to the type of the vehicle, an intermediate framework having a configuration that is semi-permanent as a function of the fittings of the vehicle and that is secured to the base framework. and a variable trim capable of covering the base framework and the intermediate framework in such a way so as to assure the aesthetic finish of the dashboard. The base framework is suitably secured to the body of the vehicle.

A dashboard assembly may comprise a first housing portion for positioning adjacent a windscreen of a motor vehicle, a second housing portion secured to the first portion, and an air blower system mounted between the first and second portions. The air blower system may have a blower inlet and blower outlets, with one or more air outlets being formed in the first portion, and one or more opensided channels being integrally formed in the first portion or the second portion for directing air from the blower outlet to the air outlet or outlets. The open side of the channel or channels may be closed on securing the first portion to the second portion. The assembly may comprise an air inlet duct for directing air to the blower inlet.

At the present time, dashboards are generally composed of a panel formed by an insert of molded plastic or metallic material, or even of dished plate, possibly covered by a skin. Their function is, in particular, to conceal the numerous housings and/or conduits, and to bear fittings, accessories, air conditioning systems and/or electrical systems provided in this area.

In such devices, the method of fixing the housings and/or conduits varies considerably from one type and/or version of a vehicle to another. Some, for instance, are secured to the rear face of the panel, others to the body of the vehicle, for example, to its front body panel.

Presently known dashboards necessitate the use of numerous intermediate pieces for support and/or fixing purposes, in particular to ensure transfer of the load in the case of the heaviest fittings and/or accessories, thus requiring a large number of assembly operations and of stock items to be handled.

As an indirect consequence, they make it necessary to restrict diversification of the external finishes to avoid yet further increasing the number of their component parts.

The assembly of presently known dashboards is also made particularly difficult by the fact that it often requires operations to be carried out “blind”, these operations further having to be conducted in a confined space such, for example, as that of a vehicle body in the process of being manufactured.

As used herein, extrusion is understood to mean the continuous melting of a plastic molding mass and ejection thereof through a shaping nozzle, such nozzle being further described herein below. Starting materials may comprise plastic materials in at least one of: granules, powders, and mixtures. Initially, the solid plastic needs to be melted. The mixture that is used then needs to be homogenized and finally needs to be cooled to the extrusion temperature.

Several extrusion equipment configurations are in use to carry out this treatment. The single-screw extruder apparatus has only one screw which rotates in a surrounding housing. The screw is supplied, by way of a feed-in opening or funnel, with the starting material. The plastic material is heated within the extruder under a substantial increase of pressure and is shaped until plasticity or melting of the material is achieved. The produced melt is mixed until a sufficient degree of homogenization is achieved. The mixing effort produces heat that needs to be continuously removed. As a rule, the mixing temperature is a temperature that is different from the extrusion temperature. This is the melting temperature within the extrusion nozzle. This temperature is lower. Accordingly, most often homogenizing is followed by a required cooling. The resulting heat that needs to be withdrawn is removed through the surrounding housing that is cooled and, in the case of modern apparatus, also through the screw that is equipped for cooling. Both these machine pieces can also be utilized to produce heat during effectuation of plasticity.

It is also known that a dashboard for a motor vehicle is supported by a dashboard support that is placed transversely between the windshield pillars of the vehicle body.

A dashboard support may typically include a support beam, e.g., a tube which is placed between the windshield pillars.

There is also known a dashboard support in the form of a rigid support beam.

As has been mentioned, in the area of the cockpit, various mountings are provided on the dashboard for retaining the instrument panel as well as further vehicle components, such as, vehicle heating, ventilating and air conditioning system, airbag, steering column, center console, fuse box, and glove compartment.

The thermoplastic polyolefin elastomer films, also referred to as thermoplastic elastomer olefinic base (TPE-O) films and thermoplastic polyolefin (TPO) films, can immediately be extruded as thin structures and/or they can be shaped by calendering to a predetermined thin dimension. To meet the demand of modern film widths, usually a broad-slot nozzle is used. The broad-slot nozzle provides the material as quasi thermoplastic film. Further dimensioning, such as, provision of width and/or thickness, is carried out the between the calender rollers. There are also known methods in which the extruded melt is deposited in a to-and-fro type movement within the calender gap.

During the calendering operation, the film is moved between at least one pair of calender rollers. It is preferred that a plurality of rollers is arranged sequentially. Distinction is made between the amount of rollers and their arrangement. The number of calender rollers is usually not greater than five. The calender rollers may all be disposed in a horizontal plane or in an inclined plane or in a vertical plane, such as, an I-shape. There are also known arrangements in which the rollers, when considered in side elevation, provide an L-shape or a Z-shape or an S-shape or an F-shape or an A-shape or a triangular shape or other shapes. It is decidedly important that the film is initially moved into a gap between the rollers. In order to attain a permanent shaping, it is a requirement that shaping is to an extent that is beyond the elasticity limit. In the case of plastic material, the elasticity limit is lowered by way of heating or the limit is lowered by moving the film through heat, however, without additional heating, from the extrusion process to between the calender rollers.

The polypropylene (PP) plastic foam layer comprises, due to reasons of applications described in the following, a crosslinked plastic. All plastics have, upon crosslinking, macromolecules that are joined to one another by way of a crosslinking reaction. For processing, the plastics need to be present as soluble or, respectively, meltable, starting materials that comprise molecules that are largely linear or, respectively, are partially crosslinked or comprise low molecular compositions. The meltability allows the option of extrusion processing. There is also provided the opportunity to produce a plastic foam. The material per se is only produced during processing comprising the crosslinking reaction. The crosslinking reaction can be achieved by way of heating, radiation, chemically, and by way of other methods.

Large utilization of the discussed composite materials with crosslinked polypropylene (PP) foam is in the automotive industry. In a vehicle many components are present that comprise a cover surface that is to have a predetermined decoration or a predetermined characteristic. Thus, the cover surface may be fashioned to achieve the appearance of a leather-covered surface. Such leather look-alike appearance imparts the impression of a value-added trim. Other decorations may be desired as well.

The cover layer may comprise a textile. Textiles are differentiated as woven material and fleece material. In the case of woven material, the textile filaments are knitted or, respectively, knotted in a predetermined order. This configures the woven material with a secure rigidity. In the case of the fleece material, the filaments are deposited in irregular, i.e., substantially random, manner one atop the other and are joined to one another, for example, by gluing or welding.

### OBJECT OF THE INVENTION

One object of the present invention resides in the production of a motor vehicle dashboard and the like structure.

### SUMMARY OF THE INVENTION

The invention teaches, in one aspect, that this object can be accomplished by a motor vehicle dashboard for a motor vehicle, said motor vehicle dashboard comprising: a frame structure, said frame structure being configured to be attached to a motor vehicle body; a first element, said first element comprising a first attachment side and a second attachment side opposite said first attachment side; said first attachment side of said first element being configured to be adhered to said frame structure of said motor vehicle dashboard; said first element comprising a first, non-crosslinked, foam, material; a second element; said second element comprising a first side being configured to be exposed towards the interior of a motor vehicle, and a second, attachment, side opposite said first side of said second element; said second element comprising a second material different from said first material of said first element; said second, attachment, side of said second element being adhered to said second attachment side of said first element; said first material and said second material forming a composite material; said first attachment side of said first element adhering to said frame structure of said motor vehicle dashboard; and at least a portion of said first side of said second element being configured to be exposed towards the interior of a motor vehicle.

The invention also teaches that this object can be accomplished by a structure comprising a foam material, said structure comprising, such as, one of: a motor vehicle dashboard, an instrument panel for a motor vehicle, an instrument panel structure for a motor vehicle, a bolster component for a motor vehicle, a body side molding for a motor vehicle, a trim portion for a motor vehicle, an armrest for a motor vehicle, a covered component for a motor vehicle, a covering for a door of a motor vehicle, a covering for an A-pillar, or a B-pillar, or a C-pillar for a motor vehicle, a protective strip for a motor vehicle, a sun visor for a motor vehicle, a covering for a door, a seat for a child, a pouch, a bag, a case, a case for a pair of glasses, a protective covering structure for an in-floor heating system, a knee pillow configured to protect knees against hard surfaces, and an insulating mat configured to insulate heated surfaces; said structure comprising: a support member; a first element, said first element comprising a first attachment side and a second attachment side opposite said first attachment side; said first attachment side of said first element being configured to be adhered to said support member; said first element comprising a first, non-crosslinked, foam, material; a second element; said second element comprising a first side being configured to be exposed, and a second, attachment, side opposite said first side of said second element; said second element comprising a second material different from said first material of said first element; said second, attachment, side of said second element being adhered to said second attachment side of said first element; said first material and said second material forming a composite material; and said first attachment side of said first element adhering to said support member.

The invention also teaches that the object can be accomplished by a method of making a structure comprising a foam material, said structure comprising, such as, one of: a motor vehicle dashboard, an instrument panel for a motor vehicle, an instrument panel structure for a motor vehicle, a bolster component for a motor vehicle, a body side molding for a motor vehicle, a trim portion for a motor vehicle, an armrest for a motor vehicle, a covered component for a motor vehicle, a covering for a door of a motor vehicle, a covering for an A-pillar, or a B-pillar, or a C-pillar for a motor vehicle, a protective strip for a motor vehicle, a sun visor for a motor vehicle, a covering for a door, a seat for a child, a pouch, a bag, a case, a case for a pair of glasses, a protective covering structure for an in-floor heating system, a knee pillow configured to protect knees against hard surfaces, and an insulating mat configured to insulate heated surfaces; said structure comprising: a support member; a first element, said first element comprising a first attachment side and a second attachment side opposite said first attachment side; said first attachment side of said first element being configured to be adhered to said support member; said first element comprising a first, non-crosslinked, foam, material; a second element; said second element comprising a first side being configured to be exposed, and a second, attachment, side opposite said first side of said second element; said second element comprising a second material different from said first material of said first element; said second, attachment, side of said second element being adhered to said second attachment side of said first element; said first material and said second material forming a composite material; and said first attachment side of said first element adhering to said support member; said method comprising the steps of: forming said first element of said first, non-crosslinked foam, material, said forming of said first element comprising forming said first element with said first attachment side and said second attachment side opposite said first attachment side of said first element; forming said second element of said second material, said forming of said second element comprising forming of said first side and said second, attachment, side opposite said first side of said second element; adhering said first element with said second attachment side of said first element to said second, attachment, side of said second element and forming said composite material; forming said composite material into a predetermined shape; providing said support member; and adhering said first attachment side of said first element to said support member.

In accordance with one aspect, the invention teaches that an improved deep-drawing capability of the corresponding material is achieved thereby that in place of the hitherto employed crosslinked polypropylene (PP) foam layer, a thermoplastic and non-crosslinked polypropylene (PP) foam layer is applied to a corresponding cover layer.

The cover layer is capable of being laminated or, respectively, welded already at a relative low content of polypropylene (PP) to the polypropylene (PP) foam layer. Results that are already agreeable are obtained when the polypropylene (PP) content in the cover layer is 5% by weight based on the weight of the plastic of the cover layer. The more the polypropylene (PP) content is increased, the better are the laminating and welding results. Accordingly, it is preferred that the polypropylene (PP) content is at least 30% by weight and still further preferred is at least 50% by weight. The thermoplastic polyolefin elastomer film, TPE-O or TPO, achieves this with a corresponding matrix comprising polypropylene (PP).

In accordance with one aspect of the invention, the non-crosslinked polypropylene (PP) foam layer comprises a special polypropylene (PP) that has a high melt strength (HMS). The term non-crosslinked as used herein is also to include a branched polypropylene. Branched polypropylene (PP) can comprise structure-isomerical propylene polymers that are generated in a modifying step that follows the polymerization synthesis. Particularly advantageous are long chain branchings or long chain branches. The branched polypropylene (PP) is similar in structure to low density polyethylene (LDPE), is thermoplastic, and foams well. Crosslinked polypropylene (PP) can be foamed depending on the degree of crosslinking but, due to crosslinking, can not be melted.

The non-crosslinked polypropylene (PP) that is used in accordance with one aspect of the invention is selected from among the many offered non-crosslinked polypropylenes (PP) and is distinguished from other, non-crosslinked, polypropylene (PP) thereby that a fine melt strand thereof has a certain melt strength. For the determination of the melt strength, the plastic is held in a cylinder as melting fluid or in the molten state and it is ejected by being pressed through a nozzle with a piston. The exiting melt strand is grasped between two rollers or cylinders and is withdrawn with increasing acceleration until the strand is torn off. The tensile force at the point of tearing off is referred to as the melt strength. The determining parameters of the procedure are: diameter of the nozzle—1 millimeter, length of nozzle—20 millimeters, melt temperature—200 degrees Celsius, cylinder interior diameter—15 millimeters, acceleration during melt withdrawal—0.12 millimeters per second-squared, melt output from nozzle—1 cubic centimeter per minute, melt strength is to be—at least 5 grams (cN) [centi-Newtons].

The polypropylene (PP) of high melt strength (HMS) quality can also be present in blends with other plastics. Preferably, a blending of polypropylene (PP) of high melt strength (HMS) quality and polypropylene (PP) homopolymers or polypropylene (PP) copolymers takes place. Among these, the polypropylene (PP) homopolymers are preferred.

Depending on the density of the polypropylene (PP) foam, there may be added from about 5% to about 70% by weight of polypropylene (PP) homopolymers, based on the total amount of plastic, to the polypropylene (PP) of high melt strength (HMS) quality. In other words, with respect to this range it is to be understood that the range includes within the range, the amounts of the stated limits and the amounts between the stated limits, for examples 6% by weight, 7% by weight etc., 67% by weight, 68% by weight, and 69% by weight and fractions thereof and possibly amounts outside the stated limits.

Polypropylene (PP) of high melt strength (HMS) quality is a standard plastic material, that is offered, for example, by the company Basell and by the company Borealis. Polypropylene (PP) of high melt strength (HMS) quality is described, inter alia, in the following printed publications: magazine: “KUNSTSTOFFE [Plastic Materials],” 1992, pages 671 ff.; U.S. Pat. No. 4,916,198; German Patent No. 3,220,269 corresponding to U.S. Pat. No. 4,522,955 issued to Fukushima et al. on Jun. 11, 1985 and entitled “Highly foamed polypropylene product and an extrusion process for forming the product;” German Patent publication No. 1,504,355; and German Patent publication No. 6,307,637. All the foregoing patent references and the foregoing article are hereby incorporated by reference as if set forth in their entirety herein. The companies mentioned in the foregoing are, respectively: Borealis Technology Oy, Porvoo, Finland; and at least one of: Basell Technology Company BV, Hoofdorp, The Netherlands; Basell Polyolefine GmbH, Wesseling, Germany; and Basell Poliolefine Italia S.p.A., Milan, Italy.

Various foaming agents can be used to effectuate foaming of the plastic used in accordance with one aspect of the invention. Chemical and physical foaming agents are differentiated. Chemical foaming agents can be added as additive components to the starting material and react, for example, under pressure and/or temperature, under the liberation of gas. The chemical foaming agents include those that are produced by the isocyanate-water-reaction, this reaction producing carbon dioxide as foaming gas. In the case of a physical process, by way of addition of low-boiling liquids, the exothermically reacting blend is foamed by evaporation of the foaming agent. For reasons of environmental protection, in place of the formerly used fluorocarbon hydrocarbons (German abbreviation: FCKW) nowadays the less damaging or non-damaging hydrogen fluoride carbons (HF(C)) and/or hydrocarbons are used.

In accordance with another feature of the invention, in particular there are used hydrocarbons, such as, propane, butane, isobutane, pentane, either exclusively or in combination with other foaming agents. The foaming agent component of the hydrocarbons in the foaming agent mixture is at least 50% by weight based on the total amount of foaming agent. It is preferred that the component of the hydrocarbons is greater, selectively also 90% by weight based on the total amount of foaming agent, and more. This applies to thin layers of the foam, without detrimentally affecting the foam. Other components of the foaming agent mixture can be inert gases, in particular carbon dioxide and nitrogen. Their proportion may be selectively up to about 25% by weight. The foaming agent quantity amounts, in relation to the total amount of plastic, in relation to the thickness of the foam, and in relation to the composition of the foaming agent mixture, to between 3 and 15% by weight.

The use of an extruder is advantageous for the manufacture of the foam. The physical foaming agents described in the foregoing are preferably injected as liquids, at the appropriate location, into the extruder. The dispersion zone or, respectively, the homogenization zone at the extruder is suitable to effectuate injection. The extruder distributes the foaming agent in finest form into the melt. This condition can be supported by stabilizers and seed formers. Ahead of the extrusion nozzle in the extruder, a considerable pressure increase occurs in the melt. The melt leaves through the nozzle into a space having an essentially lower surrounding pressure, preferably natural surrounding pressure. Because of the pressure drop, the foaming agent and/or the foaming gas that is present in the melt in finely divided form, expands. A cell forming occurs in the melt. The size of the cell and the extent of foaming, also referred to as degree of foaming, can be controlled with various assisting means, including the mentioned stabilizers and seed formers. The above-described manufacture of non-crosslinked polypropylene (PP) foam may be termed a direct foaming, because the desired degree of foaming is effectuated in a single step. This differs essentially from the hitherto employed manufacture of crosslinked foam for such composite material: In the customary method, initially an elongate foam web is produced having a low degree of foaming. The actual foaming is carried out during a second step during a successive passage through a furnace. Within the furnace, crosslinking as precondition for a permanent foaming is achieved. For this method step the furnace and the input and output devices comprise a rather bulky configuration. In comparison, the method hitherto used shows a high energy consumption.

The composite material in accordance with the invention has a higher heat resistance than the known composite material. In comparison with the known crosslinked polypropylene (PP) foam, a non-crosslinked foam can be utilized that has a greater polypropylene (PP) content, and that imparts the higher heat resistance and, because of this, imparts an enhanced capability with respect to deep-drawing to the foam.

The cell size of the foam is 0.5 to 4 millimeters, preferably 0.5 to 1.5 millimeters. The thickness of the composite material is 0.5 to 10 millimeters, and more, preferably 2 to 4 millimeters. The greater thicknesses are preferably achieved thereby that further polypropylene (PP) foam layers are successively laminated atop of one another. In the composite material, the cover layer has preferably a weight of at least 120 grams per square meter, further preferred at least 320 grams per square meter, and still further preferred at least 520 grams per square meter. In the case of textiles, the weight details per area correspond to the customary industrial characterization. Due to reasons of uniformity, the weight per area has been given also for films and elongate webs. On the basis of the weight per area, a person skilled in the art determines the thickness of the film or elongate web, by way of the specific weight of the material and by way of the volume of the film or elongate web per square meter. The higher weight per area of the cover layer enhances various characteristics of the composite material, such as, for example, the strength of the composite material or, respectively, of the cover layer.

The specific gravity of the composite material is 20 to 400 kilograms per cubic meter, preferably 30 to 150 kilograms per cubic meter.

The composite material in accordance with the invention exhibits an enhanced capability with respect to deep-drawing, in the positive direction and also in the negative direction. This applies in the case of bulging of the film in the direction of the polypropylene (PP) foam, as well as in the case of bulging in the direction of the polypropylene (PP) cover layer. Since the composite material is not crosslinked, the composite material in accordance with the invention is recycled with greater ease.

Preferably, the composite material, upon corresponding heating, can be placed against the surface that provides the shape, such that the decorative patterns are formed at the side of the composite material that can be seen.

Typical decorative patterns are so-called grains that convey the appearance of leather. The required heating may necessitate a short overheating of the upper surface of the composite material to temperatures about or above the melting temperature, so as to achieve a desired formation of the decorative pattern.

The high heat resistance and the higher capability with respect to deep-drawing also provide new methods of utilization in comparison to the hitherto known methods described in the foregoing.

The polypropylene (PP) foam layer and the polypropylene (PP) cover layer can be combined by way of laminating. During laminating, the polypropylene (PP) foam and/or the polypropylene (PP) cover layer are brought, for a short period time, to plasticity. The minimal heating is 20 degrees Celsius below the melting point. The polypropylene (PP) cover layer can be brought to the required temperature thereby that a highly warm contact surface of the polypropylene (PP) foam layer provides heat to the polypropylene (PP) cover layer. The heat can also flow from a highly warm contact surface of the polypropylene (PP) cover layer to a contact surface of the polypropylene (PP) foam layer that is less warm.

The melting point of the cover layer, when using thermoplastic polyolefin elastomer (TPE-O or TPO) in accordance with the selected material, is at 120 to 170 degrees Celsius, the melting temperature for polypropylene (PP) is from 145 to 170 degrees Celsius. For both layers the materials selection is done in such a way that the composite material has a heat resistance of from 140 to 180 degrees Celsius. It is preferred in this that a polypropylene (PP) foam material is used that has a melting point above 155 degrees Celsius, still further preferred is more than 165 degrees Celsius.

During the heating of the surface to be laminated to the laminating temperature, for short periods of time, the melting temperature can reach up to 250 degrees Celsius, without essentially negatively affecting the material. The heating for short periods of time ensures that only the uppermost material layer reaches plasticity and the layers beneath are not affected. The heated films are immediately brought or pressed against one another between suitable rollers or cylinders. It is within the scope of the invention that in the case of the polypropylene (PP) foam and/or the polypropylene (PP) cover layer an optimal temperature is not maintained, that is, when the temperature at one or the other surface is considerably below the melting point. Then there arises a joining having a lower degree of durability and an increased tendency towards delamination than in the preferred laminating process.

The laminating process can be done in a separate process step. The necessary upper surface temperatures are then brought about by means of suitable heat sources. Suitable heat sources are, for example, heat radiators or heated air blowers. The heat can also be applied by means of contact with hot cylinders or by means of flames.

The joining of the thermoplastic polyolefin elastomer film (TPE-O or TPO) to the polypropylene (PP) foam can also be achieved, in the case of calendering, thereby that upon shaping of the thermoplastic polyolefin elastomer film (TPE-O or TPO), the polypropylene (PP) foam, configured as film, is moved against the hot thermoplastic polyolefin elastomer film (TPE-O or TPO). This makes possible that the heat content of the thermoplastic polyolefin elastomer film (TPE-O or TPO) can be utilized to bring the contact surface of the polypropylene (PP) foam film to the desired temperature. In dependence of the temperature of the thermoplastic polyolefin elastomer film (TPE-O or TPO), at the contact surface of the thermoplastic polyolefin elastomer film (TPE-O or TPO), a cold (room temperature) or less pre-heated polypropylene (PP) foam film can be brought to the laminating temperature.

A further variant of the invention provides that the foam film is extruded onto the cover layer. Details of such process are described in “KUNSTSTOFFTECHNIK THERMOPLASTISCHE PARTIKELSCHAUMSTOFFE, [Plastic Technology Thermoplastic Particle Foam Materials],” 1996, VDI Verlag GmbH, Düsseldorf, section entitled “Verfahren zur Verbundbauteil-Entwicklung [Methods for Development of Composite Material Components],” FIG. 9 and accompanying description. This publication is hereby incorporated by reference as if set forth in its entirety herein. With the process, a sufficient heating, of the contact surface of the cover layer, by the plastic foam that has been extruded atop the cover layer can arise so that a direct joining is produced. Selectively, the connection can be supported by a preheating of the cover layer.

As has been explained in the foregoing, a large area of application is in motor vehicles. The composite material can therein serve to replace materials at locations, such as: cover components, additive components, sun visors, coverings for A-columns, B-columns, and C-columns, space protective strips. Improvement can thereby be achieved in: configuration of corner locations and structures with at least one bent portion, simplification of manufacture, lowering of the costs, savings in energy consumption, improvement of the rigidity, process security and safety, lower cycle times, improved conditions for the placement of hinges, light supports or mirror supports, frames, clips, electronic components, inlays of other materials, elements that can be installed by addition, improvement of the haptic characteristics, ecological gain, recycling capability, improved decorative qualities, higher dimensional accuracy, weight reduction, pure manufacture as to type, savings in connection with the elimination of tempering of plastic parts, elimination of fold formation, uniform quality, a composite with improved material adhesion and shape stability.

The composite material in accordance with the invention is also suited, in addition to the described applications in the motor vehicle area, for various applications which require an enhanced quality of the upper surface and an artistic configuration or decorative surfaces. Such other applications include items of furniture, seats for children, bags and handbags of any type, containers, such as, for glasses.

Application of the composite material in in-floor heaters is possible. In-floor heaters comprise a heating coil that is disposed in the flooring. It is customary to cover the heating coil with structural bodies. The upper surface of such structural bodies may comprise the composite material in accordance with one aspect of the invention.

In the covering of doors and, in conjunction with laminated textiles, the composite material in accordance with the invention can serve to replace other materials. Similarly, other materials used for knee pillows or insulating mats can be replaced by the composite material of the invention.

In the case of application, the utilization of the composite material, for example, may be limited to a cut material configuration. In other applications, the composite material, as elongate web or in cut material configuration, can additionally be thermoformed. During thermoforming, the composite material is heated and is subsequently shaped. The provision of necessary heat is reduced, in the event that the composite material contains a certain amount of heat achieved during its manufacture.

The thermoforming can be done in customary manner in a press between a female die structure and a male die structure. Thermoforming may be done alone or additionally with application of pressure, such as, suction (vacuum) and/or, at the opposite side, by the application of pressure, such as, air pressure.

In further applications, joining of the cut material can be done to other structures and/or workpieces that are fully or partially complete. The term structures and/or workpiece is to be understood in the broad sense. These may be parts that are straight and/or round and/or have corners. They may comprise textiles or other films. The composite material according to the invention can serve to configure furniture portions, such as, backrests and seats. The polypropylene (PP) cover layer described in the foregoing, as a rule, remains the outer portion in combination with other structures and/or workpieces. There the cover layer is to fashion the upper surface. The polypropylene (PP) foam layer is then positioned inwardly. Various joining techniques are suitable for joining, for example, gluing and welding.

The further structures and/or workpieces, with which a combination is desired, may be non-foamed or foamed plastics. Many materials do not pose a problem with gluing. Joining to other structures and/or workpieces can be made by way of welding or laminating. The joining by welding and laminating to a further structure and/or workpiece makes sufficient heating of the contact surfaces a prerequisite, as has been described in the foregoing with respect to laminating and welding. The means for heating can be the same as described above with reference to connections comprising laminated or welded connections between the polypropylene (PP) cover layer and the polypropylene (PP) foam layer. Next to heating, the capability to be welded and the capability to be laminated are respectively prerequisites. The same requirements as to the minimum of polypropylene (PP) in the material as in the production of the composite material comprising a polypropylene (PP) cover layer and a polypropylene (PP) foam layer apply. Particularly advantageous results are gained in the case of utilization of the same material of construction for the polypropylene (PP) foam and for the further structure and/or workpiece. Therefore, the further structures and/or workpieces preferably comprise polypropylene (PP) at least in part.

When it is contemplated in the combination that the composite material is to be in contact adjacent to a formed surface of the corresponding structure and/or workpiece fully or partially, the composite material is selectively adapted to the surface by a prior thermoforming. In order to effectuate thermoforming, the invention also uses known equipment and methods as they are described in: “KUNSTOFFTECHNIK, THERMOPLASTISCHE PARTIKELSCHAUMSTOFFE [Plastics Technology, Thermoplastic Particle Foam Materials],” 1996, VDI-Verlag GmbH, Düsseldorf, section “Neue Verfahren der Verbundbauteil-Entwicklung [New Methods in the Development of Composite Components],” pages 133-163. This publication is hereby incorporated by references as if set forth in its entirety herein.

Thermoforming of the composite material is done as a matter of choice in a separate step. Thermoforming may comprise a heating of the composite material that takes place outside of the tool or mold. Such heating facilitates a homogeneous heating such that tempering of the resulting structure need not be done. With respect to timing, thermoforming may be done prior to joining to a further structure and/or workpiece such that the composite material practically cools again; so that it needs to be fully re-heated for welding or, respectively, laminating at the locations that are to be welded or, respectively, laminated. In the event of short time intervals, the composite material still contains residual heat from thermoforming at the locations that are to be welded or, respectively, laminated, and the re-heating comprises a more or less low re-heating. The period of time may be utilized for a desired, as given by the circumstances, lowering of the temperature within the polypropylene (PP) foam in the composite material, so as to stabilize sensitive polypropylene (PP) foam types. The temperature limits can readily be determined by several experiments. In the case of the re-heating, the temperature, at the locations that are to be welded or, respectively, laminated, can be raised for a short period of time without problems to above the thermoforming temperature, since the polypropylene (PP) foam has a low heat conductivity.

As a matter of choice, the joining to a further structure and/or workpiece can be done by laminating in a single procedure while thermoforming/deep-drawing the composite material. During the procedure an optimal heat utilization is achieved.

During deep-drawing or, respectively, thermoforming, a more or less penetrating heating of the composite material to the shaping temperature takes place. In simultaneous thermoforming of the composite material and its joining to a further structure and/or workpiece, it may be of advantage, due to the differing requirements made of heating for thermoforming and the heating for laminating, to carry out the penetrating heating of material for the deep-drawing step at a markedly lower temperature level than the heating for laminating. The temperature may be, for example, 20 degrees Celsius, and more, below the laminating temperature described in the foregoing. The correct temperature can readily be determined by several experiments. It is surprising that the heat-treated foam of the composite material does not collapse.

The heat required for thermoforming/deep-drawing is preferably applied on both sides of the composite material. The composite material may also be heated outside of the deep-drawing equipment and/or within the deep-drawing equipment. When heating outside of the deep-drawing equipment takes place, the heating device may be stationary. When heating within the deep-drawing mold takes place, there are preferably used movable heating devices that can be moved into the open mold.

The deep-drawing equipment can operate with the force of pressure or the force of pull. In the production of a pulling force, a vacuum is applied to the heated composite material. The necessary sealing between the composite material and the mold for deep-drawing is achieved by suitable peripheral clamping of the material. For vacuum operation, a low vacuum of from 0.1 bar can already be sufficient. It is of advantage that the deep-drawing mold, for application of the vacuum, comprises a porous material or is perforated. The wall of the mold may comprise: porous resins, sintered metals, lattice structures, tools that have been subsequently perforated, or tool inserts. In contrast to a press tool proper, there will be assured the precise contour formation, variance in thickness and the filling of a region of at least one bent portion (flow of material at locations that are configured with small radii) at the composite material. The at least one bent portion, for example, at a sun visor, is preferably produced using a sleeve-type structure or, respectively, a spectacle-type structure. The sleeve-type structure or, respectively, spectacle-type structure is disposed between the plane of separation of the tools or, respectively, the plane of separation of the tool portions that fashion the viewable side of the product or, respectively, is arranged between the peripheral separating edges of the tool. The inner diameter of the sleeve-type structure or the spectacle-type structure is smaller by the amount of the portion that is to be structured to comprise at least one bent portion, than the outer dimension of the form body or structure that is to be produced. The composite material that is to be deep-drawn is pressed by this sleeve-type structure into the female die structure and, by means of the vacuum, is pressed against the opposite mold portion and in this manner is positioned about the sleeve-type structure. The projecting film is severed, as required, and remains, during assembly or after joining to other structures, in free spaces that are hidden from view. The positioning or, respectively, bending of the cover layer or of the composite material is effectuated by suitably shaped tools.

As a matter of choice, the structures and/or workpieces, to which the composite material is joined, in a further embodiment of the invention, may be part of the deep-drawing mold or, respectively, may be an aid in the deep-drawing process. In this, the structures and/or workpieces are positioned in the deep-drawing equipment in such a way that the composite material, during deep-drawing, is moved in the direction against the structure and/or workpiece and is positioned with contact between corresponding surfaces. As a matter of choice, this is used so as to produce a joining by way of welding or laminating as has been described in the foregoing.

The described deep-drawing using vacuum can be done in various ways in the deep-drawing equipment. Basically, one vacuum conduit is provided for the deep-drawing equipment. So as to permit a complete and short timed evacuation of air between the composite material and the further structure and/or workpiece, the further structure and/or workpiece comprises a suitable upper surface which enhances the evacuation of trapped air. For example, evacuation is facilitated by a suitable roughness of the upper surface and/or fine porosity and/or the structure and/or workpiece is fully or partially air-permeable. It is surprising that a structure is sufficiently air-permeable even when it comprises particle foam. Particle foam comprises small foam particles with a diameter of, for example, 0.5 to 15 millimeters. The small foam particles are produced separately and are filled into a mold for shaping a structure. This is usually effectuated under pressure with compressed air until the mold is completely filled. Air removal is done next. The compressed air escapes or, respectively, is removed by hot steam. The hot steam has a temperature so that the surfaces of the particles become molten. The resultant pressure causes welding of the foam particles to one another. However, welding is not completely done over the entire area. Small gusset regions remain. It is surprising that the evacuation of the deep-drawing mold can be done through such a particle foam structure.

By choice, a further structure and/or workpiece can be joined to the composite material according to the invention. This consideration proceeds from customary shaping for the manufacture of structures made of plastics. This may comprise:

(a) injection molds, into which the molten mass is injected with or without a foaming agent, and

(b) automatic molding machines into which plastic foam particles are introduced, as described in the foregoing, and these are joined to one another by means of steaming.

In these cases a composite material is introduced only as a cut material or as thermoformed, cut material. The surface of laminating or surface of welding of the composite material is, prior to introduction into the mold, or within the mold, brought to such a temperature that plastic introduced by injection molding of a melt or, respectively, the plastic foam or the foam particles that have been introduced, combine with the composite material. The heating of the corresponding surfaces of the composite material can be done in a manner as is described above in reference to laminating. Furthermore, a heating of these surfaces at the composite material in the automatic molding machine can be done with the steaming device thereof. As a matter of choice, one or several bursts of steam are produced to preheat the corresponding surfaces of the composite material, prior to filling with the foam particles. The preheating of the corresponding surfaces at the composite material in the mold can be dispensed with when, during injection molding or, respectively, injection foaming or, respectively, the steaming of the foam particles in the automatic molding machine, sufficient heat is made available that is adequate for heating of the corresponding surfaces of the composite material. In the production of foam bodies, the above-described procedure is referred to a production of foam backing. The foam backing is customary for motor vehicle covers, for example, side covers, sun visors. This also applies to foam backing of textiles. In the event that the composite material is spaced away from the surrounding walls of the mold cavity, the plastic mass or, respectively, the plastic foam enters there between and in the production of foam bodies, this action is referred to as foam surrounding.

The above described automatic molding machines include selectable shaping tools that are configured in such a way that the female die structure corresponds to the outer contour of the product that is to be manufactured, comprises a porous material or is perforated. Use can be made hereby of porous resins, sintered metals, lattice structures, tools that have been subsequently perforated or tool inserts. The production of the tool halves can be done by producing a mother model and by molding with a porous or pore-forming resin or by means of milling of porous semifinished products, for example, made of resin or sintered metal. Structuring of the upper surface of the tool or of portions thereof is selectively done by etching of the tool or the upper surface of the mother model. Structuring of the upper surface of the mother model may also be achieved by a lacquer that produces a structuring.

The above-described resultant materials are fully finished structures or semifinished structures that are intended for further processing. The further processing may also comprise the application of further material layers such as, lacquers, films, textiles. These may serve to increase the scratch resistance and UV radiation resistance of the cover layer.

The above-discussed embodiments of the present invention will be described further herein below. When the word “invention” is used in this specification, the word “invention” includes “inventions”, that is the plural of “invention”. By stating “invention”, the Applicants do not in any way admit that the present application does not include more than one patentably and non-obviously distinct invention, and maintains that this application may include more than one patentably and non-obviously distinct invention. The Applicants hereby assert that the disclosure of this application may include more than one invention, and, in the event that there is more than one invention, that these inventions may be patentable and non-obvious one with respect to the other.

### BRIEF DESCRIPTION OF THE DRAWINGS

The invention is explained in greater detail below with reference to the accompanying drawings.

FIG. 1 is a perspective view of a motor vehicle with a plurality of items made of a composite material in accordance with one embodiment of the present invention;

FIG. 2 is a perspective view of the forward interior portion of a motor vehicle with a dashboard in accordance with another embodiment of the present invention;

FIG. 3 is a perspective view of a dashboard in accordance with a further embodiment of the present invention

FIG. 4 is a cross-section along line IV-IV in FIG. 3;

FIG. 5 is a cross-section through a composite material in accordance with one embodiment of the present invention;

FIG. 6 is a cross-section through a composite material in accordance with another embodiment of the present invention;

FIG. 7 is a further cross-section illustrating the connection between a composite material and supporting frame structure in accordance with one embodiment of the present invention;

FIG. 8 is a flowsheet illustrating process steps in accordance with one embodiment of a method of the present invention;

FIG. 9 is an elevational view of a sun visor in accordance with one embodiment of the present invention; and

FIG. 10 is a schematic representation of a mold for molding composite material in accordance with one embodiment of the present invention.

### DESCRIPTION OF THE PREFERRED EMBODIMENTS

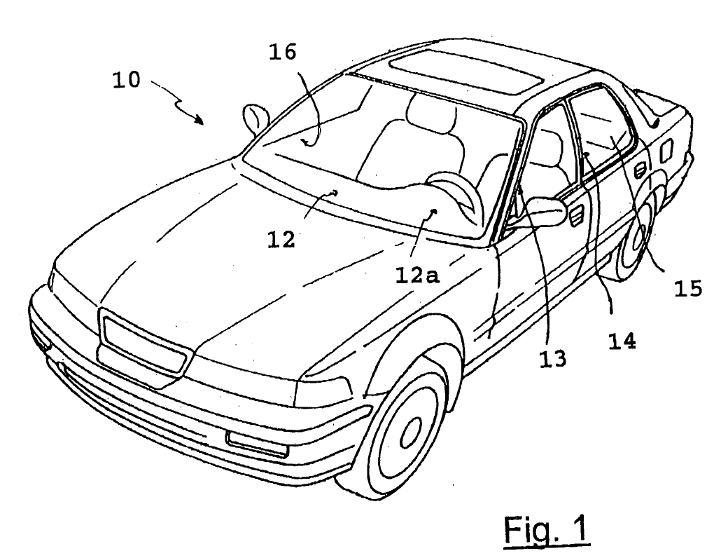

FIG. 1 illustrates a motor vehicle 10 having a dashboard 12 in accordance with one embodiment of the present invention. Door columns 13 and 14 may be constructed in analogous manner to the construction of dashboard 12 as will be described in greater detail herein below. Similarly, the motor vehicle 10 may comprise an instrument panel structure 12a, a rearward shelf panel 15, and door side trim 16, all made in a manner analogous to that of the dashboard 12.

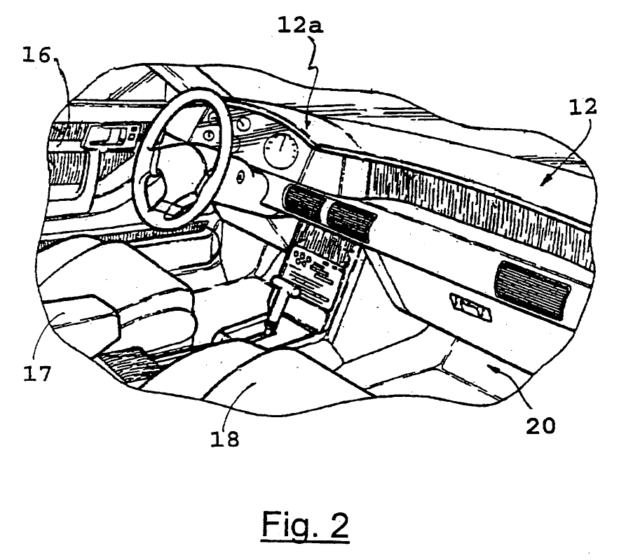

FIG. 2 shows the forward interior 20 of a motor vehicle. The interior comprises a dashboard 12 in accordance with one embodiment of the invention as will be described in greater detail herein below. The dashboard 12 extends from the driver's side to the passenger side and may be of customary configuration as is known in the art and may include an instrument panel 12a. FIG. 2 also illustrates door side trim 16, as well as portions of seats, such as, an arm rest 17 and a seat 18, that may be made in a manner analogous to the manufacture of the dashboard 12.

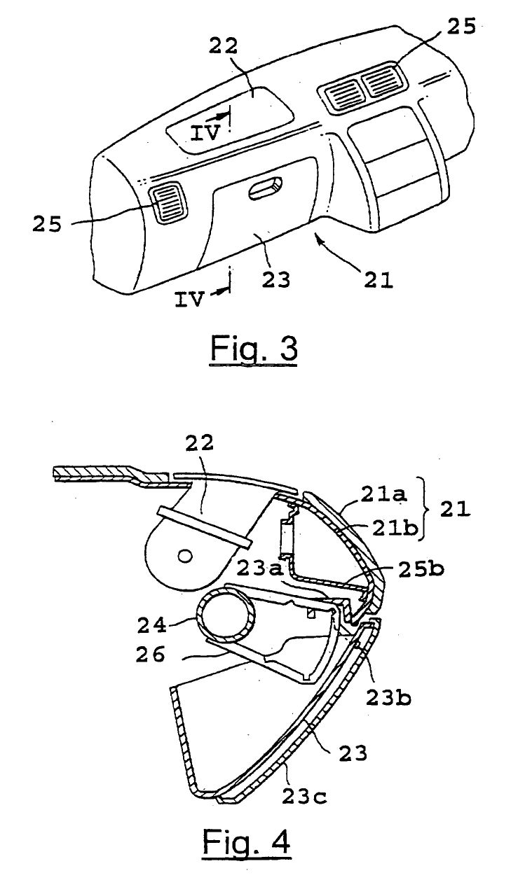

FIG. 3 is a perspective view of one embodiment of an instrument panel or dashboard structure 21 in accordance with one embodiment of the present invention.

FIG. 3 shows an air bag compartment 22, for a front passenger, that may be mounted in the upper portion of the instrument panel or dashboard structure 21. A glove box 23 may be arranged in the lower portion of the instrument panel or dashboard structure 21.

As is shown in greater detail in FIG. 4, the dashboard structure 21 comprises an instrument panel cover 21a that covers the outside surface of the instrument panel core or supporting frame structure 21b. Instrument panel cover 21a may comprise a composite material as will be described in greater detail herein below.

The glove box or glove compartment 23 is possibly arranged in the instrument panel 21. As shown in FIG. 4, the glove box 23 is kept closed by a locking mechanism which engages with a striker 23b mounted at a bracket 23a. The bracket 23a, including the striker 23b, is mounted on the inside of the instrument panel 21.

A lid 23c covers the front surface of the glove box 23, i.e., the surface facing the front passenger seat.

A steering support beam 24 and an air-conditioning duct 25 are arranged within the instrument panel 21. The steering support beam 24 may be laterally laid across the front of the driver's seat and the front passenger seat. Both ends of the steering support beam 24 are connected to the front pillars (not shown) respectively to support the steering system on the side of the driver's seat.

A knee guard 26 is mounted on the steering support beam 24 on the front passenger seat side at positions to face the lid 23c of the glove box 23. The knee guard 26 is substantially a U-shaped element. Both ends of knee guard 26 are connected to the steering support beam 24 respectively.

Thus, FIG. 4 particularly illustrates the dashboard components at a glove box or glove compartment of a motor vehicle interior.

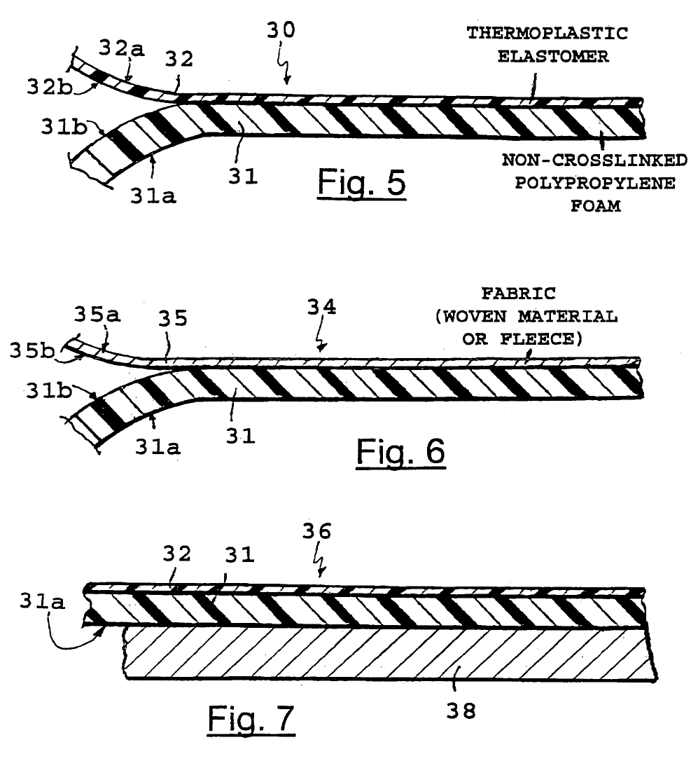

FIG. 5 shows a cross-section of a composite material 30 in accordance with one embodiment of the present invention. The composite material 30 has a first element 31. The first element 31 has a first attachment side 31a and a second attachment side 31b opposite said first attachment side 31a. The first attachment side 31a of the first element 31 is configured to be adhered to a supporting frame structure of a motor vehicle dashboard as described above. In this embodiment, the first element 31 may comprise a first, non-crosslinked, foam, material, more particularly, a non-crosslinked, polypropylene, foam, material.

The composite material 30 comprises a second element 32 that has a first side 32a that is exposed towards the interior of a motor vehicle upon installation of the composite material 30 in a motor vehicle. The second element 32 also has a second, attachment, side 32b that is opposite the first side 32a of the second element 32. In this example, the second element 32 comprises a thermoplastic elastomer material. It will be appreciated that the second, attachment, side 32b of the second element 32 is adhered to the second attachment 31b side of the first element 31 upon installation.

FIG. 6 shows a cross-section of a further embodiment of a composite material, generally identified by reference numeral 34. The composite material 34 has a first element 31. The first element 31 has a first attachment side 31a and a second attachment side 31b opposite said first attachment side 31a. The first attachment side 31a of the first element 31 is configured to be adhered to a supporting frame structure of a motor vehicle dashboard as described above. In this embodiment, the first element 31 comprises a first, non-crosslinked, foam, material. More particularly, the first element 31 may comprise a non-crosslinked, polypropylene, foam, material.

The composite material 34 comprises a second element 35 that has a first side 35a that is exposed upon installation of the composite material 34, say on an item of furniture. The second element 35 also has a second, attachment, side 35b that is opposite the first side 35a of the second element 35. In this example, the second element 35 comprises a fabric, such as, a woven material or a fleece material. It will be appreciated that the second, attachment, side 35b of the second element 35 is adhered to the second attachment 31b side of the first element 31 upon installation.

FIG. 7 shows a cross-section of an installed composite material 36 that is installed on a support structure 38. The composite material 36 a first element 31 and a second element 32 atop the first element 31. The first element 31 has a first attachment side 31a that is adhered to the upper surface of the support structure 38.

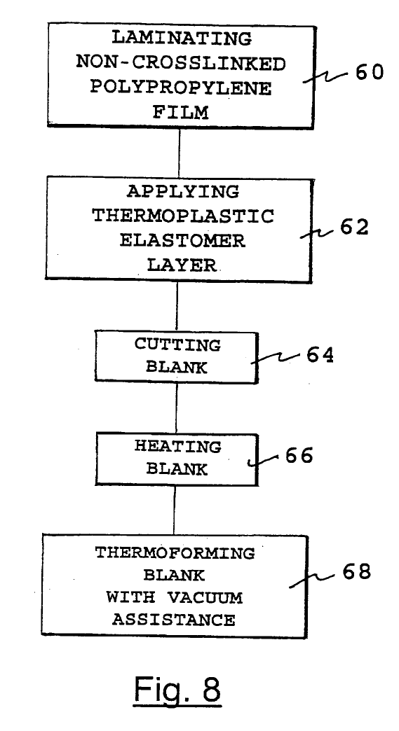

FIG. 8 is a flowsheet illustrating process steps in accordance with one embodiment of a method in accordance with the present invention.

Thus, in step 60 a plurality of non-crosslinked polypropylene foam films is laminated together to produce a block of polypropylene foam. In step 62, a thermoplastic elastomer layer is applied as top layer on the block of polypropylene. This may be by adhering through welding, co-extrusion, and the like procedure to join materials to one another. According to step 64, a blank is cut to the predetermined configuration for end-use. The blank may possibly be preheated in step 66 and is then thermoformed using vacuum in step 68. It will be appreciated that the described method is only an example and that modifications thereof are within the scope of the present invention.

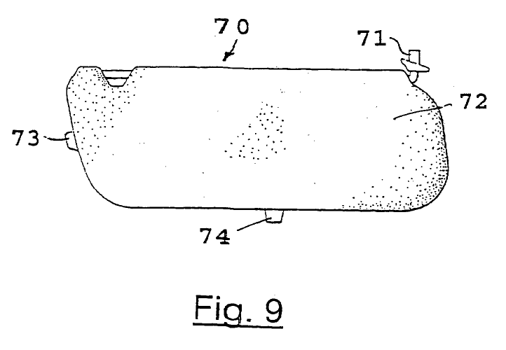

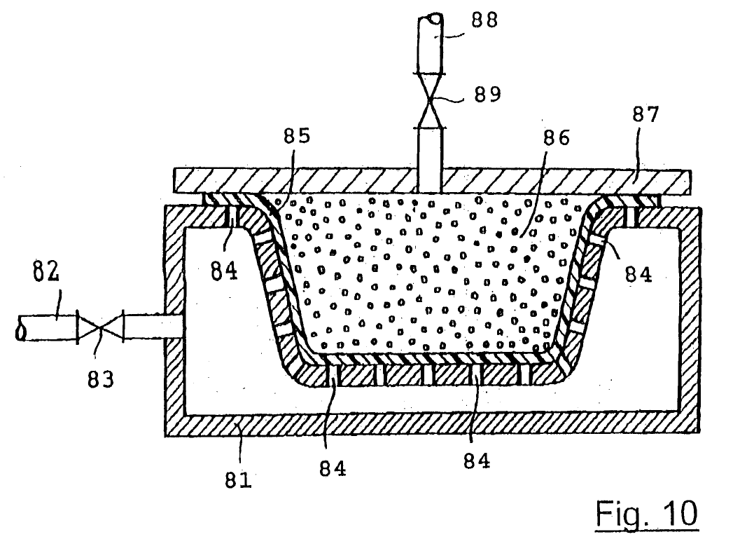

FIG. 9 is an elevational view of a sun visor 70 in accordance with one embodiment of the present invention. The sun visor 70 may be attached to a motor vehicle by visor arm 71 which enables the visor to be rotated about vertical and horizontal axes, thereby enabling the visor 70 to be placed in a desired position. Visor 70 may possibly include a lower auxiliary glare screen which may be pulled down by way of pull tab 74. Visor 70 may possibly include a lateral auxiliary glare screen that may be pulled out by way of pull tab 73. The material 72 of sun visor 70 may comprise a composite material as has been described herein above.

FIG. 10 is a schematic representation of a mold for molding a composite material in accordance with one embodiment of the present invention. More particularly, FIG. 10 schematically shows the shape of an automatic molding machine comprising a bottom part 81 and a top part 87. The peripheral edges may be sealed. Into the bottom part 81 is positioned a composite material, generally identified by reference numeral 85. After the mold has been closed, the mold cavity is evacuated via a line 82 by opening a valve 83. The vacuum is generated by pumping out the air. Its place is taken by compressed air flowing in simultaneously via a line 88 owing to the opening of a valve 89. Beads are fed in with the air. The beads may possibly have a diameter of 3 millimeters and may comprise polypropylene. The air pressure may be 6 bar. The compressed air flows through the composite material layer 85. The composite material layer 85 takes up the compressed air in an optimum manner and guides it to openings 84 in the bottom part 81. The composite material layer 85 may be a two-layer structure as described herein above. Upon suitably filling the mold cavity, superheated steam, instead of air, is forced through line 88 into the mold cavity. The superheated steam flows through the beads. During this process, the air is displaced between the beads. The steam heats up the beads and their surfaces soften. The increase in temperature causes the beads to expand. Owing to the softened outer surface of the beads and the pressure, welding takes place at all the points of contact between the beads. At the same time, the gaps between the beads are closed. After adequate cooling following opening of the mold, the finished product 86 is removed from the mold cavity.

It will be appreciated that the molding procedure described in the foregoing is only by way of example and other embodiments are within the scope of the present invention.

The invention is further described by the following example.

### EXAMPLE

3 foam films of non-crosslinked polypropylene with a density of respectively 50 grams per liter are welded together by means of flame laminating, into a composite material having a thickness of 9 millimeters. Subsequently, a TPO layer having a polypropylene matrix is directly laminated from a broad-slot nozzle with a thickness of 1 millimeter onto the polypropylene (PP) film. The composite, as cut material for a sun visor half-shell with insert structures, is heated for 25 minutes in a furnace to 155 degrees Celsius. Upon passage of time, post-heating of the surface is done by heating for 45 seconds to 185 degrees Celsius. Immediately thereafter, the composite is introduced into the thermoforming apparatus and is shaped using vacuum assistance on both sides. The assisting vacuum treatment is already prepared during the closing operation.

One feature of the invention resides broadly in the method for the production of a composite material having two or more layers that has: (a) a polypropylene (PP) cover layer that can be laminated or, respectively, welded, particularly a thermoplastic polyolefin elastomer film (TPE-O or TPO) film and/or a textile that preferably comprises a woven material or fleece; (b) with the cover layer preferably having a weight of at least 120 grams per square meter, further preferred a weight of at least 320 grams per square meter, and still further preferred a weight of at least 520 grams per square meter; (c) with a polypropylene (PP) foam layer, preferable configured as a film or elongate web; (d) by extrusion of a foam of non-crosslinked polypropylene (PP) that in a melt test has a melt strength of at least 5 cN, with the polypropylene (PP) melt, at a temperature of 200 degrees Celsius at an output of 1 cubic centimeter per minute, being pressed from a container into a nozzle that has an opening width of 1 millimeter and a length of 20 millimeters, and the melt strand that is leaving is grasped and removed with increasing acceleration under measuring of the tensile force until being torn off; (e) and a laminated connection or welded connection between the two layers.

Another feature of the invention resides broadly in the method characterized thereby that when using material blends, the part of polypropylene (PP) in the cover layer and/or in the foam layer is at least 5% by weight, preferably at least 30% by weight, and still further preferred at least 50% by weight, related to the total amount of plastic in the respective layer.

Yet another feature of the invention resides broadly in the method characterized thereby that polypropylene (PP) of high melt strength (HMS) quality is used as the polypropylene (PP) foam, preferably a mixture of polypropylene (PP) copolymers and polypropylene (PP) homopolymers, or still further preferred only polypropylene (PP) homopolymers, with the polypropylene (PP) component of the mixture being 5% to 70% by weight based on the total amount of plastic.

Still another feature of the invention resides broadly in the method characterized thereby that the composite material comprises blends of materials, which comprise only partially plastic and the balance being a filler that is not a plastic.

A further feature of the invention resides broadly in the method characterized thereby that a polypropylene (PP) composite material is selected that has a heat resistance of 155 degrees to 165 degrees Celsius.

Another feature of the invention resides broadly in the method characterized thereby that a foaming agent is used that has a hydrocarbon content of at least a 50% by weight, preferably more than 90% by weight, in relation to the total amount of foaming agent, for the production of the polypropylene (PP) foam.

Yet another feature of the invention resides broadly in the method characterized by the use of inert gases as foaming agents with a content of up to 25% by weight in relation to the total amount of foaming agent.

Still another feature of the invention resides broadly in the method characterized by the use of carbon dioxide and/or nitrogen as inert gases.

A further feature of the invention resides broadly in the method characterized thereby that the foam is extruded with a cell size of 0.4 to 4 millimeters, preferably a cell size of 0.5 to 1.5 millimeters and/or preferably with a thickness of from 0.5 to 10 millimeters, still further preferred with a thickness of 2 to 4 millimeters and/or a specific gravity of 20 to 400 kilograms per cubic meter, preferably a specific gravity of 30 to 150 per cubic meter.

Another feature of the invention resides broadly in the method characterized thereby that the polypropylene (PP) foam layer that is intended for the composite material, upon leaving the extrusion nozzle, is directly applied with a foam thickness that is specified for the composite material.

Yet another feature of the invention resides broadly in the method characterized thereby that (a) the polypropylene (PP) cover layer and the polypropylene (PP) foam layer and the thermoplastic polyolefin elastomer film (TPE-O or TPO) are joined to one another, after a short heating of the contact surfaces, to a temperature that is at most 20 degrees Celsius below the melting temperature, by laminating or, respectively, welding; (b) the foam for the polypropylene (PP) foam layer is directly applied as a foam onto the cover layer; or (c) the cover layer is extruded onto the foam film.

Still another feature of the invention resides broadly in the method characterized thereby that the polypropylene (PP) material is selected to have a melting point greater than 155 degrees Celsius and preferably greater than 165 degrees Celsius, and a thermoplastic polyolefin elastomer material (TPE-O or TPO) is selected as the cover layer so that a composite material is attained that has a heat resistance of from 140 to 180 degrees Celsius.

A further feature of the invention resides broadly in the method characterized thereby that during or, respectively, after calendering of the thermoplastic polyolefin elastomer film (TPE-O or TPO), the polypropylene (PP) foam film is moved against the hot thermoplastic polyolefin elastomer film (TPE-O or TPO).

Another feature of the invention resides broadly in the method characterized thereby that: (a) the composite material is connected to a further structure or, respectively, workpiece, the joining especially comprising laminating or welding; or (b) a further structure or, respectively, workpiece is added to the composite material by molding.

Yet another feature of the invention resides broadly in the method characterized thereby that the composite material during its production is thermoformed or is thermoformed prior to the combining with the further structure or, respectively, and/or during the joining to the further structure or, respectively, workpiece.

Still another feature of the invention resides broadly in the method characterized by a thermoforming of the composite material in a mold by means of air pressure and/or drawing by suction.

A further feature of the invention resides broadly in the method characterized thereby that the heating of the composite material to the forming temperature and/or to the welding temperature or laminating temperature is done in the mold and/or anteriorly of the mold, particularly in a furnace.

Another feature of the invention resides broadly in the method characterized thereby that the heating of the composite material to welding temperature or laminating temperature is done with utilization of the heat from the thermoforming step.

Yet another feature of the invention resides broadly in the method characterized thereby that the further structure or, respectively, workpiece is placed in the mold that is provided for thermoforming and that the composite material is pressed against or pulled against the further structure or, respectively, workpiece and is fully or partially in contact thereat.

Still another feature of the invention resides broadly in the method characterized by an air conducting surface at the further structures or, respectively, workpieces and/or an air-permeability of the further structures or, respectively, workpieces.

A further feature of the invention resides broadly in the method characterized by the use of air-permeable particle-foam structural molded parts.

Another feature of the invention resides broadly in the method characterized thereby that the composite material: (a) is positioned in an automatic molding machine and the mold cavity is filled with foam particles and the foam particles are welded by means of steaming to one another and to the composite material; (b) positioned in an injection molding mold and molten plastic, preferably foaming agent laden melt that welds to the composite material, is injected into the mold cavity.

Yet another feature of the invention resides broadly in the method characterized by preheating of the weldment locations at the composite material for joining to the further structure or, respectively, workpiece.

Still another feature of the invention resides broadly in the method characterized thereby that during thermoforming an embossing of a surface, in particular the graining, of the composite material is performed.

A further feature of the invention resides broadly in the method characterized thereby that for surface embossing of the composite material, upon penetrating heating of the composite material to the temperature of thermoforming, an additional heating of the surface that is to be embossed to the embossing temperature is contemplated.

One feature of the invention resides broadly in the method characterized thereby that for thermoforming and/or the joining with other structures or, respectively, workpieces and/or for the connecting to other structures or, respectively, workpieces a porous mold and/or a mold with perforations is utilized.

Another feature of the invention resides broadly in the method characterized thereby that the mold is made of a porous resin, particularly a pore-resin, or is made of metal, particularly a sintered metal.

Yet another feature of the invention resides broadly in the method characterized thereby that for the making of the mold, a mother mold is formed or that the mold is made from a semifinished body by removal of material.

Still another feature of the invention resides broadly in the method characterized thereby that for thermoforming of the composite material a mold is utilized in which the composite material is held by a sleeve-type structure (Manschette) or spectacle-type structure (Brille), that have inner dimensions which correspond to the outer dimensions of the composite material that is to be formed.

A further feature of the invention resides broadly in the method characterized thereby that a divisible mold is utilized with the sleeve-type structure (Manschette) or spectacle-type structure (Brille) being arranged to be in the separating region of the mold and preferably are arranged at the mold component or, respectively, mold half that is located at the viewable side of the product.

Another feature of the invention resides broadly in the method characterized by at least one bent portion of a thermoplastic polyolefin elastomer film edge (TPE-O or TPO) which projects in reference to the foam layer in the mold or, respectively, by at least one bent portion of an edge of the composite material which projects in reference to a further structure and/or workpiece.

Yet another feature of the invention resides broadly in the method characterized by the manufacture of at least one bent portion by means of slides.

Still another feature of the invention resides broadly in the method characterized by the use for the manufacture of motor vehicle parts, items of furniture, seats for children, pouches of all types, cases, such as, for glasses, floor heating systems, coverings for doors, knee pillows, insulating mats.

In one aspect, this invention relates to composite materials, their manufacture and use.

In another aspect, the invention relates to composite materials comprising, on the one hand, a polypropylene (PP) cover layer that can be laminated or, respectively, welded and that, more particularly, comprises a thermoplastic polyolefin elastomer film, TPE-O film, also referred to as TPO film herein, or that comprises a textile, such as, a woven material or fleece, joined to a polypropylene (PP) foam layer, in particular configured as a film or elongate web or strip. In at least one embodiment of the invention, the composite material is configured as an elongate web or strip.

Composite material having a thermoplastic polyolefin elastomer film, TPE-O film, also referred to as TPO film herein, as cover layer is primarily known in the automotive industry. For details of such thermoplastic polyolefin elastomer films, TPE-O or TPO films, reference is made to the following U.S. Pat. No. 4,843,129 issued to Spenadel et al. on Jun. 27, 1989 and entitled “Elastomer-plastic blends;” No. 4,871,799 issued to Kobayashi et al. on Oct. 3, 1989 and entitled “Thermoplastic polymer composition;” No. 5,011,891 issued to Spenadel et al. on Apr. 30, 1991 and entitled “Elastomer polymer blends;” No. 5,594,080 issued to Waymouth et al. on Jan. 14, 1997 and entitled “Thermoplastic elastomeric olefin polymers, method of production and catalysts therefor;” No. 5,665,822 issued to Bitler et al. on Sep. 9, 1997 and entitled “Thermoplastic elastomers;” No. 5,763,534 issued to Srinivasan et al. on Jun. 9, 1998 and entitled “Thermoplastic polypropylene blends with mixtures of ethylene/butene and ethylene/octene copolymer elastomers;” No. 5,783,302 issued to Bitler et al. on Jul. 21, 1998 and entitled “Thermoplastic elastomers;” No. 5,786,403 issued to Okada et al. on Jul. 28, 1998 and entitled “Foamable olefin thermoplastic elastomer compositions and foamed products thereof;” No. 5,985,971 issued to Srinivasan et al. on Nov. 16, 1999 and entitled “Thermoplastic polypropylene blends with mixtures of ethylene/butene and ethylene/octene copolymer elastomers;” No. 5,998,524 issued Srinivasan et al. on Dec. 7, 1999 and entitled “Thermoplastic polypropylene blends with mixtures of ethylene/butene and ethylene/octene copolymer elastomers;” No. 6,140,420 issued to Sehanobish et al. on Oct. 31, 2000 and entitled “Impact-modified thermoplastic polyolefins and articles fabricated therefrom;” No. 6,180,709 issued to Nishio et al. on Jan. 30, 2001 and entitled “Thermoplastic polypropylene composition;” No. 6,245,856 issued to Kaufman et al. on Jun. 12, 2001 and entitled “Thermoplastic olefin composition;” and No. 6,268,064 issued to Kim on Jul. 31, 2001 and entitled “Polypropylene compound for extruded body side molding.”All the foregoing U.S. patents are hereby incorporated by reference as if set forth in their entirety herein.

It may be mentioned that hitherto thermoplastic polyolefin elastomer films, TPE-O or TPO films, are predominantly produced by extrusion and are treated in a calender machine, the treating initially comprising smoothing and/or graining or, respectively, embossing or, respectively, are provided with a design at the upper surface. Subsequently, a foam layer comprising a crosslinked ethylene/propylene copolymer is laminated onto the thermoplastic polyolefin elastomer film, TPO or TPE-O film, or is added thereto during calendering.

In accordance with one object of the invention, while the known composite material comprising a polypropylene (PP) cover layer and a crosslinked plastic foam has been proven, the invention, however, has as one object the aim to improve such material. In this, the invention, in one aspect proceeds from the recognition that the heat resistance of known composite materials, at approximately 110 degrees Celsius, determines the capability of deep-drawing thereof.

In other words, in one aspect, the present invention relates to a composite material that comprises a polypropylene cover layer and a non-crosslinked polypropylene foam backing or foam layer.

The cover layer is not only to have a decorative effect. The cover layer also has to withstand the temperatures that are experienced within a motor vehicle.

Both aims are achieved in a superior manner by a composite material comprising a cover layer described in the foregoing and with a crosslinked plastic foam layer. This applies to dashboards for indicators and controls, arm rests, door side covers, hat storage platforms, for the covering of hat storage platforms, and others. The foam back of the composite material can be utilized to eliminate uneven spots or locations in an advantageous manner and a soft, resilient surface with a pleasant appearance can be achieved.

An ethylene/propylene copolymer is used as the crosslinked plastic foam layer. In modern motor vehicles the cover elements that are used are to be shaped into a predetermined configuration that can be achieved by thermoforming of the composite material. Most often, the thermoforming is a deep-drawing process.

The polypropylene cover layer is capable of being laminated. Lamination may comprise gluing or some other suitable joining. Lamination may also comprise thermal welding. Thermal welding may comprise the heating of the layers to an extent such that the layers become tacky or sticky and are able to adhere to one another without the benefit of an adhesive.

In at least one embodiment, the polypropylene cover layer comprises a film comprised of a thermoplastic polyolefin elastomer, such as TPE-O or TPO.

In at least one embodiment of the present invention, the cover layer may possibly comprise a textile, that is, a woven material or a fleece, that is correspondingly joined to the non-crosslinked polypropylene foam backing or layer.

Polypropylene is defined in HAWLEY'S CONDENSED CHEMICAL DICTIONARY, thirteenth Edition, Revised by Richard J. Lewis, Jr., published by John Wiley & Sons, Inc., 1997, New York, as follows: polypropylene: CAS:9003-07-0 (C₃H₅)ₙ. A synthetic crystalline, thermoplastic polymer with molecular weight of 40,000 or more. Note: Low molecular weight polymers are also known that are amorphous in structure and used as gasoline additives, detergent intermediates, greases, sealants, and lubricating oil additives. Also available as a high melting wax. Derivation: Polymerization of propylene with a stereospecific catalyst such as aluminum alkyl. Properties: Translucent, white solid. D 0.90, mp 168-171 degrees Celsius, tensile strength 5000 psi, flexural strength 7,000 psi, usable up to 121 degrees Celsius. Insoluble in cold organic solvents; softened by hot solvents. Maintains strength after repeated flexing. Degraded by heat and light unless protected by antioxidants. Readily colored; good electrical resistance; low water absorption and moisture permeability; poor impact strength below minus 9.4 degrees Celsius; not attacked by fungi or bacteria; resists strong acids and alkalies up to 60 degrees Celsius but is attacked by chlorine, fuming nitric acid, and other strong oxidizing agents. Combustible but slow burning. Fair abrasion and good heat resistance if properly modified. Can be chrome-plated, injection- and blow molded, and extruded. Available forms: (Molding powder) Extruded sheet, cast films (1-10 mils), textile staple and continuous filament yarn, fibers with diameters from 0.05 to 1 micrometers, and fiber webs down to 2 microns thick, low density foam, Use: Packaging film; molded parts for automobiles, appliances, housewares, etc.; wire and cable coating; food container closures; coated and laminated products; bottles; artificial grass and turfs; plastic pipe; wearing apparel (acid-dyed); fish nets; surgical casts; strapping; synthetic paper; reinforced plastics; nonwoven disposable filters.

Polypropylene is defined in THE MERCK INDEX, An Encyclopedia of Chemicals, Drugs, and Biologicals, Thirteenth Edition, 2001, published by Merck Research Laboratories Division of Merck & Co., Whitehouse Station, N.J., 2001, as follows: 7663. Polypropylene. [9003-07-0] 1-Propene homopolymer; propylene polymer. Class of compounds also known as olefins. Three forms are possible. Isotactic (fiber forming): methyl groups are all on same side of plane of zig-zag carbon atom chain. Syndiotactic: methyl groups are on alternate sides of plane of carbon atom chain. Atactic (not fiber-forming, amorphous ): methyl groups are in a random arrangement with respect to plane of carbon atom chain. Early synthesis of isotactic form with Ziegler catalyst and comparison with atactic form: Natta et al., J. Chem. Soc. 77, 1708 (1955); Natta, J. Polymer Sci. 16, 143 (1955). Reviews: N. G. Gaylord. H. F. Mark, Linear and Stereoregular Addition Polymers (Interscience, New York, 1959) pp 54-65; R. W. Moncrieff. Man-Made Fibres (Wiley, New York, 4th ed., 1963) pp 500-510; J. G. Cook, Handbook of Textile Fibres (Merrow Publishing Co., England, 3rd ed., 1964) pp 369-379; G. Crespi, L. Luciani, “Olefin Polymers (Polypropylene)” in Kirk-Othmer Encyclopedia of Chemical, Technology Vol. 16 (Wiley-lnterscience, New York, 3rd ed., 1981) pp 453-469. Review of thermal decomposition and toxicity: V. Purohit. R. A. Orzel, J. Am. Coll. Toxicol. 7, 221-242 (1988).

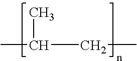

Isotactic form. Amco; Amerfil; Beamette; Courlene PY; DLP; Gerfil; Herculon; Lambeth; Meraklon; Moplen; Olane; Prolene; Tuff-Lite; Ulstron. Solid material, softens at˜155 degrees Celsius, mp ˜165 degrees Celsius. Low flammability comparable to that of wool. Keeps strength down to minus 100 degrees Celsius. d 0.90-0.92. Practically insol in cold org solvents. Sol in hot decalin, hot tetralin, boiling tetrachloroethane. Shrinks in boiling trichichloroethylene. Resistant to acids, alkalies; attacked by strong oxidizing agents, e.g., hydrogen peroxide. Good resistance to abrasion (“pilling”). Tendency to develop static charges. Unstabilized material has poor resistance to sunlight. Difficult to dye, lacks dye-attracting polar groups in structure. USE: Isotactic form: for fishing gear, ropes, filter cloths, laundry bags, protective clothing, blankets, fabrics, carpets, yarns, et cetera.

The section entitled “OLEFIN POLYMERS (POLYPROPYLENE),” in Kirk-Othmer, “Encyclopedia of Chemical Technology,” fourth edition, Vol. 17, 1996, A Wiley-lnterscience Publication, John Wiley & Sons, New York, pages 784 ff. is hereby incorporated by reference as it if set forth in its entirety herein.

In at least one possible embodiment of the invention, the term “thermoplastic” is to have the meaning of the definition in HAWLEY'S CONDENSED CHEMICAL DICTIONARY, thirteenth Edition, Revised by Richard J. Lewis, Jr., published by John Wiley & Sons, Inc., 1997, New York, which definition is as follows:— “thermoplastic. A high polymer that softens when exposed to heat and returns to its original condition when cooled to room temperature. Natural substances that exhibit this behavior are crude rubber and a number of waxes; however, the term is usually applied to synthetics such as polyvinyl chloride, nylons, fluorocarbons, linear polyethylene, polyurethane prepolymer, polystyrene, polypropylene, and cellulosic and acrylic resins.”

Likewise, in at least one embodiment the term “elastomer” is to have the meaning of the definition as provided in HAWLEY'S CONDENSED CHEMICAL DICTIONARY, thirteenth Edition, Revised by Richard J. Lewis, Jr., published by John Wiley & Sons, Inc., 1997, New York, which definition is:— “elastomer. As originally defined by Fischer (1940), this term referred to synthetic thermosetting high polymers having properties similar to those of vulcanized natural rubber, namely, the ability to be stretched to at least twice their original length and to retract very rapidly to approximately their original length when released. Among the better-known elastomers introduced since the 1930s are styrene-butadiene copolymer, polychloroprene (neoprene), nitrile rubber, butyl rubber, polysulfide rubber, (“Thiokol”), cis-1,4-polyisoprene, ethylene-propylene terpolymers (EPDM rubber), silicone rubber, and polyurethane rubber. These can be cross-linked with sulfur, peroxides, or similar agents. The term was later extended to include uncross-linked polyolefins that are thermoplastic; these are generally known as TPO rubbers. Their extension and retraction properties are notably different from those of thermosetting elastomers, but they are well adapted to such specific uses as wire and cable coating, automobile bumpers, vibration dampers, and specialized mechanical products.”

It will be appreciated that the terms “un-cross-linked,” “uncross-linked,” and “non-crosslinked” are interchangeable in meaning.

In at least one embodiment of the present invention, the term “thermoforming” has the meaning as provided by the definition in HAWLEY'S CONDENSED CHEMICAL DICTIONARY, thirteenth Edition, Revised by Richard J. Lewis, Jr., published by John Wiley & Sons, Inc., 1997, New York, which definition is as follows:— “thermoforming. (1) See reforming. (2) Forming or shaping a thermoplastic sheet by heating the sheet above its melting point, fitting is along the contours of a mold with pressure supplied by vacuum or other force, and removing it from the mold after cooling below its softening point. The method is applied to polystyrenes, acrylics, vinyls, polyolefins, cellulosics, etc.”

Some examples of non-crosslinked or uncross-linked or un-cross-linked polypropylene, features of which may possibly utilized or adapted for use in at least one possible embodiment of the present invention may possibly be found in the following U.S. Pat. No. 4,567,208 issued to Kubawara et al. on Jan. 28, 1986 and entitled “Preliminarily foamed particles of non-crosslinked polypropylene-type resin;” No. 4,596,833 issued to Endo et al. on Jun. 24, 1986 and entitled “Polypropylene foamed particles;” No. 4,587,279 issued to Kubawara et al. on May 6, 1986 and entitled “Preliminarily foamed particles of non-crosslinked polypropylene-type resin;” No. 4,626,555 issued to Endo et al. on Dec. 2, 1986 and entitled “Polypropylene foamed particles;” No. 4,704,239 issued to Yoshimura et al. on Nov. 3, 1987 and entitled “Process for the production of expanded particles of a polymeric material;” No. 5,928,776 issued to Shioya et al. on Jul. 27, 1999 and entitled “Composite material having polypropylene foam layer;” and No. 6,416,699 issued to Gownder et al. on Jul. 9, 2002 and entitled “Reduced shrinkage in metallocene isotactic polypropylene fibers.” All of the foregoing U.S. Patents are hereby incorporated by reference as if set forth in their entirety herein.

Some examples of the use of TPE-O, features of which may possibly be used or adapted for use in at least one possible embodiment of the present invention, may be found in the following U.S. Pat. No. 5,792,532 issued to Pfleger on Aug. 11, 1998 and entitled “Polymer tubing;” No. 5,803,489 issued to Nusshör on Sep. 8, 1998 and entitled “Gas bag cover for a vehicle occupant restraining system and method for the manufacture thereof;” No. 5,968,381 issued to Nusshör on Oct. 19, 1999 and entitled “Method for the manufacture of a gas bag cover using laser scoring;” No. 6,444,065 issued to Reil et al. on Sep. 3, 2002 and entitled “Method of making rotable rolls of plastic material;” No. 6,517,936 issued to Ciocca et al. on Feb. 11, 2003 and entitled “Multi-layer stretch film;” and No. 6,579,584 issued to Compton on Jun. 17, 2003 and entitled “High strength flexible film package utilizing thin film.”All of the foregoing U.S. patents are hereby incorporated by reference as if set forth in their entirety herein.

In at least one embodiment of the present invention TPE-O may comprise a polyolefin thermoplastic elastomer, such as, EXACT (TM) grades from the Exxon Chemical Company, and the ENGAGE (TM) polyolefins from The Dow Chemical Company. The trademarked products may also be referred to as “ethylene alpha-olefin copolymer”, and “ethylene/alpha-olefin copolymer” and are, as stated available as homogeneous ethylene/alpha olefin copolymers or are available as metallocene-catalyzed EXACT (TM) linear homogeneous ethylene/alpha olefin copolymer resins from the Exxon Chemical Company, of Baytown, Tex., and as ENGAGE (TM) resins available from the Dow Chemical Company, of Midland, Mich. The ENGAGE (TM) resins have a relatively large number of short branches in combination with a relatively small number of long-chain branches. Further details, such as, properties of EXACT (TM) grades from the Exxon Chemical Company, and the ENGAGE (TM) polyolefins from The Dow Chemical Company, are disclosed in U.S. Pat. No. 5,770,318 issued to Friedman on Jun. 23, 1998 and entitled “Thermoplastic Seal and wrapping film;” and U.S. Pat. No. 6,287,700 issued to Kong et al. on Sep. 11, 2001 and entitled “Multi-layer film with enhanced lamination bond strength.” All of the foregoing U.S. patents are hereby incorporated by reference as if set forth in their entirety herein.

In at least one embodiment of the invention, as used herein, the term “polymer” refers to the product of a polymerization reaction, and may be inclusive of homopolymers, copolymers, terpolymers, tetrapolymers, etc. In general, the layers of a film can consist essentially of a single polymer, or can have additional polymers together therewith, i.e., blended therewith.

Also, as used herein, the term “homopolymer” may be used with reference to a polymer resulting from the polymerization of a single monomer, i.e., a polymer consisting essentially of a single type of repeating unit.

Further, as used herein, the term “copolymer” possibly refers to polymers formed by the polymerization reaction of at least two different monomers. For example, the term “copolymer” includes the copolymerization reaction product of ethylene and an alpha-olefin, such as 1-hexene. The term “copolymer” is possibly also inclusive of, for example, the copolymerization of a mixture of ethylene, propylene, 1-hexene, and 1-octene. As used herein, the term “copolymerization” possibly refers to the simultaneous polymerization of two or more monomers. The term “copolymers” is also possibly inclusive of random copolymers, block copolymers, and graft copolymers.

As used herein, a copolymer identified in terms of a plurality of monomers, e.g., “propylene/ethylene copolymer”, may refer to a copolymer in which either monomer may copolymerize in a higher weight or molar percent than the other monomer or monomers. However, the first listed monomer may preferably polymerize in a higher weight percent than the second listed monomer, and, for copolymers which are terpolymers, quadripolymers, etc., preferably the first monomer copolymerizes in a higher weight percent than the second monomer, and the second monomer copolymerizes in a higher weight percent than the third monomer, etc.

Also, as used herein, terminology employing a “/” with respect to the chemical identity of a copolymer (e.g., “an ethylene/alpha-olefin copolymer”), possibly identifies the comonomers which are copolymerized to produce the copolymer. As used herein, “ethylene alpha-olefin copolymer” is the equivalent of “ethylene/alpha-olefin copolymer.”

In at least one embodiment, as used herein, copolymers are identified, i.e., named, in terms of the monomers from which the copolymers are produced. For example, the phrase “ethylene/propylene copolymer” or “propylene/ethylene copolymer” refers to a copolymer produced by the copolymerization of both propylene and ethylene, with or without additional comonomer(s). In at least one embodiment, as used herein, the phrase “mer” refers to a unit of a polymer, as derived from a monomer used in the polymerization reaction. For example, the phrase “alpha-olefin mer” refers to a unit in, for example, an ethylene/alpha-olefin copolymer, the polymerization unit being that “residue” which is derived from the alpha-olefin monomer after it reacts to become a portion of the polymer chain, i.e., that portion of the polymer contributed by an individual alpha-olefin monomer after it reacts to become a portion of the polymer chain.

Some examples of thermoplastic olefin (TPO), features of which may possibly be used or adapted for use in at least one possible embodiment of the present invention may be found in the following U.S. Pat. No. 6,107,404 issued to Ryntz on Aug. 22, 2000 and entitled “Paintable, surface-damage resistant reactor grade thermoplastic olefin (TPO);” No. 6,253,528 issued to Hubbard et al. on Jul. 3, 2001 and entitled “Apparatus for applying TPO adhesive to a single-ply roofing membrane;” No. 6,300,414 issued to McGee et al. on Oct. 9, 2001 and entitled “Additive for coating compositions for adhesion to TPO substrates;” No. 6,451,894 issued to Srinivasan et al. on Sep. 17, 2002 and entitled “TPO blends containing multimodal elastomers;” No. 6,498,214 issued to Laughner et al. on Dec. 24, 2002 and entitled “Soft touch TPO compositions comprising polypropylene and low crystalline ethylene copolymers;” and No. 6,515,074 issued to Kakarala et al. on Feb. 4, 2003 and entitled “Thermoplastic polymer alloy compositions and process for manufacture thereof.” All of the foregoing U.S. patents are hereby incorporated by reference as if set forth in their entirety herein.

As has been stated above, thermoplastic polyolefin elastomer films, TPE-O or TPO films, are predominantly produced by way of extrusion. Subsequently, the films are treated in a calender machine, the treating initially comprising smoothing and/or graining or, respectively, embossing or, respectively, the films are provided with a design at the upper surface.

Some examples of extrusion and calendering, features of which may possibly be used or adapted for use in at least one embodiment of the present invention may be found in the following U.S. Pat. No. 4,349,592 issued to Nussbaum on Sep. 14, 1982 and entitled “Thermoplastic elastomer molding;” No. 5,702,798 issued to Sugita et al. on Dec. 30, 1997 and entitled “Composite material with controlled elasticity;” No. 5,824,400 issued to Petrakis et al. on Oct. 20, 1998 and entitled “Plastic article and process for the preparation thereof;” No. 5,994,482 issued Georgellis et al. on Nov. 30, 1999 and entitled “Polypropylene copolymer alloys and process for making;” No. 6,217,982 issued to Dawson on Apr. 17, 2001 and entitled “Thermoplastic polymer alloy composition;” No. 6,288,156 issued to Hausmann on Sep. 11, 2001 and entitled “Calenderable thermoplastic polymer compositions;” No. 6,309,736 issued to McCormack et al. on Oct. 30, 2001 and entitled “Low gauge films and film/nonwoven laminates;” and No. 6,517,936 issued to Ciocca et al. on Feb. 11, 2003 and entitled “Multi-layer stretch film.” All of the foregoing U.S. patents are hereby incorporated by reference as if set forth in their entirety herein.

Furthermore, in accordance with one aspect of the present invention, a foam layer comprising a non-crosslinked foam may be laminated onto a different material film or is added thereto during calendering.

In at least one embodiment, the thermoplastic polyolefin elastomer films, TPE-O or TPO films, may immediately be extruded as a thin structure and/or they may be shaped by way of calendering to a predetermined thickness or gauge. So as to meet the demand of modern film widths, usually a wide-slot nozzle may be used. The wide-slot nozzle issues the material as a quasi thermoplastic film. Further dimensioning, such as, the provision of the corresponding width and/or the corresponding thickness, is then carried out between the calender rollers.

The cover layer may comprise a textile. Textiles may be differentiated as woven material and as fleece. In the case of woven material, the textile filaments may be knitted or, respectively, knotted in a predetermined order. This may configure the woven material with rigidity. In the case of the fleece, the filaments may be deposited in an irregular (random) manner, one atop the other, and the filaments may be joined to one another, for example, by gluing or welding.

Some examples of woven material, features of which may possibly be used or adapted for use in at least one embodiment of the present invention may be found in the following U.S. Pat. No. 5,456,976 issued to LaMarca, II et al. on Oct. 10, 1995 and entitled “Resilient padded laminate construction and injection molded thermoplastic articles faced therewith;” No. 5,702,798 issued to Sugita et al. on Dec. 30, 1997 and entitled “Composite Material with controlled elasticity;” No. 5,846,368 issued to Sakaguchi et al. on Dec. 8, 1998 and entitled “Laminate producing process;” No. 6,124,001 issued to Sugita et al. on Sep. 26, 2000 and entitled “Method of making a composite material with controlled elasticity;” and No. 6,331,263 issued to Abe et al. on Dec. 18, 2001 and entitled “Method for producing laminated moldings.” All of the foregoing U.S. patents are hereby incorporated by reference as if set forth in their entirety herein.

Some examples of fleece material, features of which may possibly be used or adapted for use in at least one possible embodiment of the present invention may be found in the following U.S. Pat. No. 3,961,107 issued to Hammer et al. on Jun. 1, 1976 and entitled “Fiber fleece containing a polymeric reinforcing material, and process for the production of such fleece;” 5,320,015 issued to Minichshofer et al. on Jun. 14, 1994 and entitled “Apparatus for applying a fleece band to an endlessly circulating support web;” No. 5,895,611 issued to Geltinger et al. on Apr. 20, 1999 and entitled “Process for producing interior trims for transport means and interior trims produced in this process;” No. 6,502,360 issued to Carr, III et al. on Jan. 7, 2003 and entitled “Single-ply roofing membrane with laminated, skinned nonwoven;” No. 6,534,577 issued to Keller on Mar. 18, 2003 and entitled “PVC-containing material with citrate esters;” and No. 6,586,080 issued to Heifetz on Jul. 1, 2003 and entitled “Sealing sheet assembly for construction surfaces and methods of making and applying same.” All of the foregoing U.S. Patents are hereby incorporated by reference as if set forth in their entirety herein.

In accordance with one aspect of the invention, the non-crosslinked polypropylene (PP) foam layer may possibly a high melt strength (HMS) non-crosslinked polypropylene (PP). Some examples of high melt strength polypropylene comprise Pro-fax PF633 of Montell Canada, a high melt strength (HMS) polypropylene homopolymer resin, Pro-fax SD812 of Montell Canada, a high melt strength (HMS) polypropylene medium impact copolymer resin for extrusion coating, and Montell HMS Polypropylene PF814.

Some examples of high melt strength polypropylene, features of which may possibly be used or adapted for use in at least one possible embodiment of the present invention may be found in the following U.S. Pat. No. 5,180,751 issued to Park et al. on Jan. 19, 1993 and entitled “Polypropylene foam sheets;” No. 5,348,795 issued to Park on Sep. 20, 1994 and entitled “Process for making a dimensionally-stable open-cell polypropylene foam with organic blowing agents;” No. 5,811,039 issued to Addeo et al. on Sep. 22, 1998 and entitled “Process for fabricating bodies of polymeric material with foamed core;” No. 6,103,153 issued to Park et al. on Aug. 15, 2000 and entitled “Production of foamed low-density polypropylene by rotational molding;“No. 6,255,237 issued to Sakamoto et al. on Jul. 3, 2001 and entitled “Laminated sheet;” and No. 6,503,985 issued to Ellul et al. on Jan. 7, 2003 and entitled “Thermoplastic elastomers having improved set and foams made therefrom.” All of the foregoing U.S. patents are hereby incorporated by reference as if set forth in their entirety herein.

Various foaming agents may possibly be used to effectuate foaming of the plastic used in accordance with the invention. Chemical and physical foaming agents are differentiated. Chemical foaming agents may be added as an additive component to the starting material and may possibly react, for example, under pressure and/or temperature, with liberation of gas. Chemical foaming agents may possibly include an isocyanate-water-reaction. This reaction produces gaseous carbon dioxide as possible foaming gas. In the case of a physical process, by way of addition of low-boiling liquids, the exothermically reacting blend is foamed by evaporation of the foaming agent. For reasons of environmental protection, in place of the formerly used fluorocarbon hydrocarbons (German abbreviation: FCKW) nowadays the less damaging or non-damaging hydrogen fluoride carbons (HF(C)) and/or hydrocarbons are used.

In accordance with another feature of the invention, there may be used hydrocarbons, such as, propane, butane, isobutane, pentane, either exclusively or in combination with other foaming agents. The foaming agent component of the hydrocarbons in the foaming agent mixture may be at least 50% by weight based on the total amount of foaming agent. It will be appreciated that the foaming agent component may be 50% by weight, and may be 51% by weight, 52% by weight and so forth and fractions thereof.

In at least one embodiment it is preferred that the component of the hydrocarbons is greater, selectively also 90% by weight based on the total amount of foaming agent, and more. This applies to thin layers of the foam, without detrimentally affecting the foam. It will be appreciated that the hydrocarbon component may be 91% by weight based on the total amount of foaming agent, may be 92% by weight based on the total amount of foaming agent and more, and fractions thereof.

Other components of the foaming agent mixture may be inert gases, such as, carbon dioxide and nitrogen. Their proportion may be selectively up to 25% by weight. That is, the proportion of inert gases may be 24% by weight, may be 23% by weight and so forth, and fractions thereof.

The foaming agent quantity possibly amounts, in relation to the total amount of plastic, in relation to the thickness of the foam, and in relation to the composition of the foaming agent mixture, to between about 3% and about 15% by weight. In other words, with respect to this range it is to be understood that the range includes within the range, the amounts of the stated limits and the amounts between the stated limits, for examples 4% by weight, 5% by weight etc., 12% by weight, 13% by weight, and 14% by weight and fractions thereof and possibly amounts outside of the stated limits.

Some examples of foaming agents that may possibly be used or adapted for use in at least one embodiment of the present invention may be found in the following U.S. Pat. No. 4,071,591 issued to Kobayashi et al. on Jan. 31, 1978 and entitled “Method of manufacturing foamed thermoplastic resin profiles;” No. 4,146,562 issued to Fukushima et al. on Mar. 27, 1979 and entitled “Extrusion coating method with polyolefin film;” No. 6,552,095 issued to Tochioka et al. on Apr. 22, 2003 and entitled “Laminate, method for producing the same and thermoplastic foam adhesive;” No. 6,562,907 issued to Johoji et al. on May 13, 2003 and entitled “Olefin polymer and thermoplastic resin composition;” No. 6,565,795 issued to Hanada et al. on May 20, 2003 and entitled “Process for producing a thermoplastic resin-molded article;” and No. 6,576,332 issued to Yoshizaki et al. on Jun. 10, 2003 and entitled “Thermoplastic resin structure.” All of the foregoing U.S. patents are hereby incorporated by reference as if set forth in their entirety herein.

Some further examples of foaming agents, such as, propane, butane, isobutane, pentane, features of which may possibly be used or adapted for use in at least one embodiment of the present invention may be found in the following U.S. Pat. No. 4,056,576 issued to Gregory et al. on Nov. 1, 1977 and entitled “Chemical process over gallium catalyst converting saturated hydrocarbons to olefins;” No. 4,487,731 issued to Kobayashi on Dec. 11, 1984 and entitled “Process and apparatus for producing foamed synthetic resin bodies;” No. 4,746,478 issued to Fujisaki et al. on May 24, 1988 and entitled “Method and apparatus for production of foamed thermoplastic material;” No. 4,985,505 issued to Gunesin et al. on Jan. 15, 1991 and entitled “Process of dispersion polymerization of butadiene in propane or butane;” No. 5,270,395 issued to Gunesin et al. on Dec. 14, 1993 and entitled “Process of dispersion polymerization of butadiene in propane or butane;” No. 6,197,233 issued to Mason et al. on Mar. 6, 2001 and entitled “Method of forming low density strand foams;” and No. 6,506,919 issued to Oh et al. on Jan. 14, 2003 and entitled “Metallocene compounds and their use for olefin polymerization.” All of the foregoing U.S. patents are hereby incorporated by reference as if set forth in their entirety herein.

Some further examples of preparing foaming gas, such as, carbon dioxide, by way of isocyanate-water reaction, features of which may possibly be used or adapted for use in at least one possible embodiment of the present invention may be found in the following U.S. Pat. No: 4,520,141 issued to Kumasaka et al. on May 28, 1985 and entitled “Method for manufacturing phenolic resin foam;” No. 5,109,032 issued to Uekado et al. on Apr. 28, 1992 and entitled “Foamed heat insulation material;” No. 5,120,771 issued to Walmsley on Jun. 9, 1992 and entitled “Process for the production of polyurethane foam;” and No. 5,585,412 issued to Natoli et al. on Dec. 17, 1996 and entitled “Process for preparing flexible CFC-free polyurethane foam using and encapsulated blowing agent.” All of the foregoing U.S. patents are hereby incorporated by reference as if set forth in their entirety herein.

Some examples of extruder machines that may possibly be used or adapted for use for the extrusion of polypropylene foam may be found in the following U.S. Pat. No. 4,192,839 issued to Hayashi et al. on Mar. 11, 1980 and entitled “Process for producing expanded article of thermoplastic resin;” No. 4,352,892 issued to Lohmar on Oct. 5, 1982 and entitled “Method for the manufacture of lightweight foam materials from crystalline thermoplastic materials and the resultant products;” No. 4,501,543 issued to Rutledge et al. on Feb. 26, 1985 and entitled “Rotary extruder;” No. 4,958,933 issued to Zakich on Sep. 25, 1990 and entitled “Cooler-extruder device;” No. 5,259,749 issued to Meixner et al. on Nov. 9, 1993 and entitled “Apparatus for feeding synthetic resin material to injection molding and extruder units;” No. 5,297,948 issued to Sadr on Mar. 29, 1994 and entitled “Extruder screw for use in foam plastic extruder;” No. 5,993,706 issued to Wilkes et al. on Nov. 30, 1999 and entitled “Oxygenated hydrocarbon compatibilizing agent for carbon dioxide-blown polyolefinic foams;” No. 6,074,084 issued to Kolossow on Jun. 13, 2000 and entitled “Extruder for plastics;” and No. 6,287,102 issued to Franz et al. on Sep. 11, 2001 and entitled “Extruder with a shaping device.” All of the foregoing U.S. Patents are hereby incorporated by reference as if set forth in their entirety herein.

Some examples of extruders for producing a plastic film, features of which may possibly be used or adapted for use in at least one possible embodiment of the present invention may be found in the following U.S. Pat. No. 4,259,047 issued to Cole on Mar. 31, 1981 and entitled “Air ring for the production of blown film;” No. 4,388,262 issued to Brasz et al. on Jun. 14, 1983 and entitled “Method for the forming of plastics;” No. 4,810,179 issued to Cavanagh on Mar. 7, 1989 and entitled “Force indicator for casting machines;” No. 5,443,769 issued to Karabedian et al. on Aug. 22, 1995 and entitled “Polystyrene foam sheet manufacture;” No. 5,458,841 issued to Shirrell on Oct. 17, 1995 and entitled “Method for making prestretched film;” No. 5,542,836 issued to Gross et al. on Aug. 6, 1996 and entitled “Device for extruding and smoothing plastic films;” No. 5,676,791 issued to Christel on Oct. 14, 1997 and entitled “Device for producing extrusion-coated laminates;” No. 6,019,924 issued to Montalbano on Feb. 1, 2000 and entitled “Extrusion die with adjusting sliding die lips and method of use;” and No. 6,273,699 issued to Finke on Aug. 14, 2001 and entitled “Device for manufacturing plastic film.” All of the foregoing U.S. Patents are hereby incorporated by reference as if set forth in their entirety herein.

The cell size of the foam is from about 0.5 to about 4 millimeters, preferably from about 0.5 to about 1.5 millimeters. It will be appreciated that the stated range includes the stated limits of the ranges and the values between the stated limits, such as, 0.6 millimeters, 0.7 millimeters, 0.8 millimeters, etc., and 1.2 millimeters, 1.3 millimeters, 1.4 millimeters and fractions thereof, and may possibly also include values that are outside of the stated ranges..

The thickness of the composite material is from about 0.5 to about 10 millimeters, and more, preferably from about 2 to about 4 millimeters. The greater thicknesses are preferably achieved thereby that further polypropylene (PP) foam layers are successively laminated atop one another. It will be appreciated that the stated range includes the stated limits and the values between the stated limits, such as, 0.6 millimeters, 0.7 millimeters, 0.8 millimeters, etc, and 9.7 millimeters, 9.8 millimeters, 9.9 millimeters and fractions thereof, and may also include values that are outside of the stated ranges.

In the composite material, the cover layer has preferably a weight of from at least about 120 grams per square meter, further preferred from at least about 320 grams per square meter, and still further preferred from at least about at least 520 grams per square meter. It will be appreciated that the cover layer has a weight that is more than about 120 grams per square meter, such values including 121 grams per square meter, 122 grams per square meter and so forth, and preferably more than about 520 grams per square meter, such as 521 grams per square meter, 522 grams per square meter and so forth, and at least values between 120 grams per square meter and 520 grams per square meter.

In the case of textiles, the weight details per area correspond to the customary characterizations. Due to reasons of uniformity, the weight per area has been given also for films and elongate webs. On the basis of the weight per area, a person skilled in the art determines the thickness of the film or elongate web, by way of the specific weight of the material and by way of the volume of the film or elongate web per square meter. The higher weight per area of the cover layer enhances various characteristics of the composite material, such as, for example, the strength of the composite material or, respectively, of the cover layer.

The specific gravity of the composite material is from about 20 to about 400 kilograms per cubic meter, preferably from about 30 to about 150 kilograms per cubic meter. It will be appreciated that the stated range includes the stated limits and the values between the stated limits, such as, 21 kilograms per cubic meter, 22 kilograms per cubic meter, 23 kilograms per cubic meter, etc, and 397 kilograms per cubic meter, 398 kilograms per cubic meter, 399 kilograms and fractions thereof, and possibly values outside the stated ranges.

In at least one possible embodiment of the invention, the polypropylene (PP) foam layer and the polypropylene (PP) cover layer may possible be combined by way of laminating. During laminating, the polypropylene (PP) foam and/or the polypropylene (PP) cover layer are brought, for a short period time, to plasticity. The minimal heating may be about 20 degrees Celsius below the melting point. The polypropylene (PP) cover layer may be brought to the required temperature thereby that a highly warm contact surface of the polypropylene (PP) foam layer provides heat to the polypropylene (PP) cover layer. The heat may also flow from a highly warm contact surface of the polypropylene (PP) cover layer to a contact surface of the polypropylene (PP) foam layer that is less warm.

The melting point of the cover layer, when using thermoplastic polyolefin elastomer, TPE-O or TPO, in accordance with the selected material, may be in the range of from about 120 to about 170 degrees Celsius, the melting temperature for polypropylene (PP) is in the range from about 145 to about 170 degrees Celsius. For both layers the materials selection is done in such a way that the composite material has a heat resistance of from about 140 to about 180 degrees Celsius. It is preferred in this that a polypropylene (PP) foam material is used that has a melting point above about 155 degrees Celsius, still further preferred is more than 165 degrees Celsius. It will be appreciated that the stated ranges, namely, from 120 to about 170 degrees Celsius, from about 145 to about 170 degrees Celsius, and from about 140 to about 180 degrees Celsius include intermediate values and may possibly comprise values that are greater or less than the stated limits. For example, the stated range of from about 120 degrees Celsius to about 170 degrees Celsius, may possibly include 121 degrees Celsius or more, and 119 degrees Celsius, 118 degrees Celsius, etc. and fractions thereof.

In at least one embodiment of the present invention, at least one of: said first element and said second element comprises greater than about 5% solid by weight, that is 6% solid by weight, 7% solid by weight and so forth.

In at least one embodiment, the first element has a melting point of one of: (1) and (2), wherein (1) and (2) comprise: (1) greater than about 155 degrees Celsius, and (2) greater than about 165 degrees Celsius, that is, a melting point that is 155 degrees Celsius, 156 degrees Celsius, 157 degrees Celsius and so forth, as well as 165 degrees Celsius, 166 degrees Celsius and so forth.

In at least one embodiment of the present invention, the second element of the composite material has a heat resistance of from about 140 to about 180 degrees Celsius, that is a heat resistance that is 140 degrees Celsius, 141 degrees Celsius, 142 degrees Celsius and so forth, and possibly values outside the stated range.

In at least one embodiment of the present invention, the composite material has a resistance to remelting at a temperature of from about 155 to about 165 degrees Celsius, that is a temperature of 155 degrees Celsius, 156 degrees Celsius, 157 degrees Celsius and so forth.

During the heating of the surface to be laminated to the laminating temperature, for short periods of time, the melting temperature may possibly reach up to about 250 degrees Celsius, without essentially negatively affecting the material. The heating for short periods of time ensures that only the uppermost material layer reaches plasticity and the layers beneath are not affected. The heated films are immediately brought together or pressed against one another between suitable rollers or cylinders. It is within the scope of the invention that in the case of the polypropylene (PP) foam and/or the polypropylene (PP) cover layer an optimal temperature is not maintained, that is, when the temperature at one or the other surface is considerably below the melting point. Then there arises a joining having a lower degree of durability or delamination than in the preferred laminating process.

The laminating process may be done in a separate process step. The necessary upper surface temperatures may then be brought about by means of suitable heat sources. Suitable heat sources are, for example, heat radiators or hot-air blowers. The heat may also be applied by means of contact with hot cylinders or by means of flames.

Some examples of laminating thermoplastic polyolefin elastomers and foam layers, features of which may possibly be used or adapted for use in at least one embodiment of the present invention may be found in the following U.S. Pat. No. 4,859,540 issued to Bragole on Aug. 22, 1989 and entitled “Method for bonding adhesives to polyolefin surfaces and the laminate formed thereby;” No. 6,004,498 issued to Fujii et al. on Dec. 21, 1999 and entitled “Method for molding resin to skin members;” No. 6,261,489 issued to Matsuki et al. on Jul. 17, 2001 and entitled “Method of manufacturing skin-carrying internal-mold expansion molded boy of synthetic resin and metal mold used for the same method;” No. 6,328,367 issued to Eichhorn et al. on Dec. 11, 2001 and entitled “Interior covering part, particularly an instrument panel for motor vehicles;” No. 6,483,048 issued to Bontrager et al. on Nov. 19, 2002 and entitled “Automotive trim panel with electrical wiring incorporated therein;” and No. 6,552,095 issued to Tochioka et al. on Apr. 22, 2003 and entitled “Laminate, method for producing the same and thermoplastic foam adhesive:” All of the foregoing U.S. patents are hereby incorporated by reference as if set forth in their entirety herein.

The joining of the thermoplastic polyolefin elastomer film, TPE-O or TPO film, to the polypropylene (PP) foam may possibly also be achieved, in the case of calendering, thereby that upon shaping of the thermoplastic polyolefin elastomer film, TPE-O or TPO film, the polypropylene (PP) foam, configured as film, is moved against the hot thermoplastic polyolefin elastomer film, TPE-O or TPO film. This makes possible that the heat content of the thermoplastic polyolefin elastomer film, TPE-O or TPO film, can be utilized to bring the contact surface of the polypropylene (PP) foam film to the desired temperature. In dependence of the temperature of the thermoplastic polyolefin elastomer film, TPE-O or TPO film, at the contact surface of the thermoplastic polyolefin elastomer film, TPE-O or TPO film, a cool, say room temperature, or less pre-heated polypropylene (PP) foam film can be brought to the laminating temperature.

Some examples of calendering equipment, features of which may possibly be used or adapted for use in at least one possible embodiment of the present invention may be found in the following U.S. Pat. No. 4,014,636 issued to Pawelczyk on Mar. 29, 1977 and entitled “Synthetic plastics film manufacturing plant including a multiple-roll calender;” No. 4,214,857 issued to Woeckner et al. on Jul. 29, 1980 and entitled “Multi-roll calender;” No. 5,985,088 issued to Couillard et al. on Nov. 16, 1999 and entitled “Method and apparatus for an improved roller system for calender machines;” No. 6,149,563 issued to Kusters on Nov. 21, 2000 and entitled “Calender;” No. 6,261,487 issued to Bongaerts et al. on Jul. 17, 2001 and entitled “Method of and machine for controlling the nip of the rolls of a calender as an endless planar web is continuously passed through the nip;” and No. 6,568,318 issued to Kurtz on May 27, 2003 and entitled “Process for operating a calender and calender.” All of the foregoing U.S. patents are hereby incorporated by reference as if set forth in their entirety herein.

A further variant of the invention provides that the foam film may be extruded onto the cover layer or cover film. Details of such process are described in “KUNSTSTOFFTECHNIK THERMOPLASTISCHE PARTIKELSCHAUMSTOFFE, [Plastic Technology Thermoplastic Particle Foam Materials],” 1996, VDI Verlag GmbH, Düsseldorf, section entitled “Verfahren zur Verbundbauteil-Entwicklung [Methods for Development of Composite Material Components],” FIG. 9 and accompanying description. This article is hereby incorporated by reference as if set forth in its entirety herein.

With the process of the mentioned reference, a sufficient heating of the contact surface of the cover layer by the plastic foam that has been extruded atop can arise so that a direct joining is produced. Selectively, the connection may be effectuated by pre-heating the cover layer.

Some further examples particularly describing extrusion of foam, features of which may possibly be used or adapted for use in at least one embodiment of the present invention may be found in the following U.S. Pat. No. 4,613,471 issued to Harris on Sep. 23, 1986 and entitled “Extruded plastic foam density control system and method;” No. 6,090,479 issued to Shirato et al. on Jul. 18, 2000 and entitled “Shape-recoverable resin foamed product;” No. 6,329,439 issued to Peterson et al. on Dec. 11, 2001 and entitled “Extrusion of a foamable melt consisting of mixed polyolefin and rubber copolymer;“ No. 6,383,425 issued to Wu et al. on May 7, 2002 and entitled “Method for extruding foamed polypropylene sheet having improved surface appearance;” and No. 6,521,675 issued to Wu et al. on Feb. 18, 2003 and entitled “Foamed polypropylene sheet having improved appearance and a foamable polypropylene composition therefor.” All of the foregoing U.S. patents are hereby incorporated by reference as if set forth in their entirety herein.

The components disclosed in the various publications, disclosed or incorporated by reference herein, may be used in the embodiments of the present invention, as well as equivalents thereof.

Some examples of co-extrusion, features of which may possibly be used or adapted for use in at least one possible embodiment of the present invention may be found in the following U.S. Pat. No. 4,370,374 issued to Raabe et al. on Jan. 25, 1983 and entitled “Multilayer plastic film, process for its production and its use;” No. 4,488,918 issued to Jofs on Dec. 18,1984 and entitled “Non-slip plastic film;” No. 4,552,714 issued to Krueger et al. on Nov. 12, 1985 and entitled “Process for producing coextruded film of polypropylene, polypropylene blend, and nylon;” No. 5,246,769 issued to Murschall et al. on Sep. 21, 1993 and entitled “Biaxially oriented multilayer polyolefin film;” No. 5,492,757 issued to Schuhmann et al. on Feb. 20, 1996 and entitled “Opaque, matte, multilayer polypropylene film, process for the production thereof, and the use thereof;” and No. 5,811,185 issued to Schreck et al. on Sep. 22, 1998 and entitled “Low temperature heat sealable biaxially oriented polypropylene films comprising propylene/butylene resin.” All of the foregoing U.S. patents are hereby incorporated by reference as if set forth in their entirety herein.

As has been explained in the foregoing, a large area of application of our present invention is in the automotive industry. The composite material may serve in locations and applications such as, cover components, sun visors, and coverings for dashboards, A-columns, B-columns, and C-columns, or pillars, and protective strips.

Some examples of dashboards for motor vehicles in which the invention may possibly be used or adapted for use, or features of which may possibly be used or adapted for use in at least one embodiment of the present invention, may be found in the following U.S. Pat. No. 4,662,649 issued to Ikeda et al. on May 5, 1987 and entitled “Knee projector in automobile;” No. 5,676,216 issued to Palma et al. on Oct. 14, 1997 and entitled “Structural two-piece composite instrument panel cross-beam with integrated air distribution system;” No. 6,196,588 issued to Sugawara on Mar. 6, 2001 and entitled “Instrument panel structure;” No. 6,213,504 issued to Isano et al. on Apr. 10, 2001 and entitled “Automobile knee bolster structure;“ 6,371,551 issued to Hedderly on Apr. 16, 2002 and entitled “Integrated steering column, instrument panel, and cowl body structure;” and No. 6,560,872 issued to Morrison et al. on May 13, 2003 and entitled “Method of making a cross car beam assembly using a structural adhesive.” All of the foregoing U.S. patents are hereby incorporated by reference as if set forth in their entirety herein.

Some examples of sun visors in which the invention may possibly be used or adapted for use, or features of which may possibly be used or adapted for use in at least one embodiment of the present invention, may be found in the following U.S. Pat. No. 6,439,638 issued to Kawasaki et al. on Aug. 27, 2002 and entitled “Vehicle sun visor;” No. 6,512,052 issued to Jeong on Jan. 28, 2003 and entitled “Polypropylene resin composition for automobile interior covering materials;” No. 6,527,328 issued to Crotty, III et al. on Mar. 4, 2003 and entitled “Clip lock visor;” No. 6,578,895 issued to Tom on Jun. 17, 2003 and entitled “Sun visor having a corrugated core;” No. 6,582,013 issued to Inoue at al. on Jun. 24, 2003 and entitled “Vehicular ceiling assembling structure, a unit assembly used for the same, a frame member used for the same, and a vehicular ceiling assembling method;” and No. 6,585,308 issued to Sturt et al. on Jul. 1, 2003 and entitled “Visor assembly with extender blade.” All of the foregoing U.S. patents are hereby incorporated by reference as if set forth in their entirety herein.

Some examples of pillars or columns, such as, A-pillars, B-pillars, and C-pillars in which the invention may possibly be used or adapted for use, or features of which may possibly be used or adapted for use in at least one embodiment of the present invention, may be found in the following U.S. Pat. No. 5,238,263 issued to Sinnhuber on Aug. 24, 1993 and entitled “Lateral head protection arrangement for a vehicle occupant;” No. 5,938,275 issued to Kleinhans et al. on Aug. 17, 1999 and entitled “Side panel assembly for a motor vehicle body;” No. 5,979,115 issued to Szerdahelyi et al. on Nov. 9, 1999 and entitled “Twin-shell vehicle door with double-strand cable window lift mechanism pre-fitted on a support plate;” No. 6,158,796 issued to Weber on Dec. 12, 2000 and entitled “B-column roof module and a vehicle and manufacturing method utilizing same;” No. 6,189,918 issued to Stavermann on Feb. 20, 2001 and entitled “Inflatable Head protection system for the lateral area of a passenger car;” No. 6,428,038 issued to Baumann et al on Aug. 6, 2002 and entitled “Side collision damping arrangement for a vehicle;” No. 6,524,404 issued to Gehringhoff et al. on Feb. 25, 2003 and entitled “B-column for motor vehicle;” No. 6,315,353 issued to Brodt et al. and entitled “Body segment for a vehicle;” and No. 6,520,534 issued to Ritter on Feb. 18, 2003 and entitled “Inflatable occupant protective cushion.” All of the foregoing U.S. patents are hereby incorporated by reference as if set forth in their entirety herein.

The appended drawings in their entirety, including all dimensions, proportions and/or shapes in at least one embodiment of the invention, are accurate and are hereby included by reference into this specification.

Some examples of protective strips in which the invention may possibly be used or adapted for use, or features of which may possibly be used or adapted for use in at least one embodiment of the present invention, may be found in the following U.S. Pat. No. 4,083,592 issued to Rubin et al. on Apr. 11, 1978 and entitled “Protective strip assembly;” No. 4,366,885 issued to Vrijburg on Jan. 4, 1983 and entitled “Protective strip for a road vehicle, and a road vehicle having such a strip;” No. 5,096,753 issued to McCue et al. on Mar. 17, 1992 and entitled “Protective strip assembly;” No. 5,162,139 issued to Gomez et al. on Nov. 10, 1992 and entitled “Vehicular protective strip;” No. 5,283,096 issued to Greenberg et al. on Feb. 1, 1994 and entitled “Resilient strip for protective strip assembly;” and No. 5,574,087 issued to Kobayashi et al. on Nov. 12, 1996 and entitled “Molded protective strip for automobiles.” All of the foregoing U.S. patents are hereby incorporated by reference as if set forth in their entirety herein.

The composite material in accordance with the invention is also suited, in addition to the described applications in the automotive area, for various applications which require an enhanced quality of the upper surface and an aesthetic configuration or decorative surfaces. Such other applications include items of furniture, seats for children, bags, containers, pouches, and handbags of any type, containers, such as, for glasses.

Some examples of items of furniture in which the invention may possibly be used or adapted for use, or features of which may possibly be used or adapted for use in at least one embodiment of the present invention, may be found in the following U.S. Pat. No. 6,409,264 issued to Palmer et al. on Jun. 25, 2002 and entitled “Interchangeable furniture cover system;” No. 6,494,532 issued to Brosnan et al. on Dece. 17, 2002 and entitled “Soft-sculpted Furniture;” No. 6,508,899 issued to Meyer Zu Drewer et al. on Jan. 21, 2003 and entitled “System for applying edge trim to furniture panel;” No. 6,513,872 issued to Bar on Feb. 4, 2003 and entitled “Multipart upholstered furniture;” No. 6,543,844 issued to Ryan et al. on Apr. 8, 2003 and entitled “Seating furniture for children;” No. 6,568,058 issued to Wieland et al. on May 27, 2003 and entitled “Method of assembling a fully upholstered ready-to-assemble article of furniture;” and No. 6,595,592 issued to Wieland et al. on Jul. 22, 2003 and entitled “Article of furniture.” All of the foregoing U.S. Patents are hereby incorporated by reference as if set forth in their entirety herein.

All, or substantially all, of the components and methods of the various embodiments may be used with at least one embodiment or all of the embodiments, if more than one embodiment is described herein.

Some examples of seats for children in which the invention may possibly be used or adapted for use, or features of which may possibly be used or adapted for use in at least one embodiment of the present invention, may be found in the following U.S. Pat. No. 5,310,245 issued to Lyszczasz on May 10, 1994 and entitled “Cushion support apparatus for infants;” No. 5,860,696 issued to Opsvik et al. on Jan. 19, 1999 and entitled “Cushion for a chair, especially a detachable cushion for a child's seat;” No. 6,428,098 issued to Allbaugh on Aug. 6, 2002 and entitled “Child seat liner;” No. 6,237,509 issued to Reithmeier et al. on Aug. 14, 2001 and entitled “Child's seat for motor vehicles;” No. 6,568,755 issued to Groening on May 27, 2003 and entitled “Child's seat especially for mobile use in an aircraft;” No. 6,502,901 issued to Deptolla on Jan. 7, 2003 and entitled “Car seat with an integrated child seat.” All of the foregoing U.S. patents are hereby incorporated by reference as if set forth in their entirety herein.

Some examples of bags in which the invention may possibly be used or adapted for use, or features of which may possibly be used or adapted for use in at least one embodiment of the present invention, may be found in the following U.S. Pat. No. 5,892,202 issued to Baldwin et al. on Apr. 6, 1999 and entitled “Thermal storage and transport;” No. 6,018,143 issued to Check on Jan. 25, 2000 and entitled “Heat thermal bag;” No. 6,019,510 issued to Gonzalez et al. on Feb. 1, 2000 and entitled “Child's car seat carrier pouch;” No. 6,230,952 issued to Jupiter on May 15, 2001 and entitled “Sundry pouch for backpacks;” No. 6,318,613 issued to Underhill on Nov. 20, 2001 and entitled “Carrying pouch attachable to garments;” and No. 6,512,211 issued to Lockhart et al. on Jan. 28, 2003 and entitled “Storage pouch for use with an induction heater.” All of the foregoing U.S. patents are hereby incorporated by reference as if set forth in their entirety herein.

All of the patents, patent applications and publications recited herein, and in the Declaration attached hereto, are hereby incorporated by reference as if set forth in their entirety herein.

Some further examples of motor vehicle items in which the invention may possibly be used or adapted for use, or features of which may possibly be used or adapted for use in at least one embodiment of the present invention, may be found in the following U.S. Pat. No. 4,225,178 issued to Takada on Sep. 30, 1980 and entitled “Vehicle seat;” No. 4,272,103 issued to Schmid et al. on Jun. 9, 1981 and entitled “Lateral protection of motor vehicles;” No. 4,273,359 issued to Scholz et al. on Jun. 16, 1981 and entitled “Deformation member arranged in the impact area of the knee;” No. 4,721,329 issued to Brantman et al. on Jan. 26, 1988 and entitled “Elastically restoring knee bolster for motor vehicles;” No. 4,951,963 issued to Behr et al. on Aug. 28, 1990 and entitled “Self-adjusting knee bolster;” and No. 5,098,124 issued to Breed et al. on Mar. 24, 1992 and entitled “Padding to reduce injuries in automobile accidents.” All of the foregoing U.S. patents are hereby incorporated by reference as if set forth in their entirety herein.

Some examples of cases for eye glasses in which the invention may possibly be used or adapted for use, or features of which may possibly be used or adapted for use in at least one embodiment of the present invention, may be found in the following U.S. Pat. No. 3,000,417 issued to Goldstein on Sep. 19, 1961 and entitled “Eyeglass case;” No. 5,261,582 issued to Mathews et al. on Nov. 16, 1993 and entitled “Belt case for eyeglasses;” No. 5,711,417 issued to Tilve on Jan. 27, 1998 and entitled “Case for glasses;” No. 6,026,950 issued to Wisniewski on Feb. 22, 2000 and entitled “Eyeglass case with glasses-engaging bump;” and No. 6,398,017 issued to Cafiero on Jun. 4, 2002 and entitled “Case for glasses.” All of the foregoing U.S. patents are hereby incorporated by reference as if set forth in their entirety herein.

Application of the invention in in-floor heaters is possible. In-floor heaters may comprise a heating coil that is disposed in the flooring. It is customary to embed the heating coil in structural bodies. The upper surface of such structural bodies may comprise the material in accordance with our invention.

Some examples of in-floor heater systems in which the present invention may possibly be used or adapted for use and features of which may possibly be used or adapted for use in at least one possible embodiment of the invention may be found in the following U.S. Pat. No. 4,878,332 issued to Drake on Nov. 7, 1989 and entitled “Electric radiant floor heating system;” No. 5,097,893 issued to Trimble on Mar. 24, 1992 and entitled “Counter flow tube-manifold radiant floor heating system;” No. 5,788,152 issued to Alsberg on Aug. 4, 1998 and entitled “Floor heating system;” No. 5,811,758 issued to Choi on Sep. 22, 1998 and entitled “Under floor heating system of a heat accumulating type and a method for storing thermal energy;” No. 5,908,573 issued to Chiles et al. on Jun. 1, 1999 and entitled “Electric floor heating system;” and No. 6,159,954 issued to Maeda on Mar. 6, 2001 and entitled “Method of improving durability of a building, building, far-infrared radiation thermal storage floor heating system.” All of the foregoing U.S. patents are hereby incorporated by reference as if set forth in their entirety herein.

All of the patents, patent applications or patent publications, which were cited in the International Search Report, dated as to mailing Aug. 22, 2002, and/or cited elsewhere are hereby incorporated by reference as if set forth in their entirety herein as follows: EP 0 515 223, corresponding to U.S. Pat. No. 5,532,055 issued to Igarashi et al. on Jul. 2, 1996 and entitled “Composite foam molded article process for production thereof, and foamable powder composition,” and U.S. Pat. No. 5,744 issued to Igarashi et al. on Apr. 28, 1998 and entitled “Composite foam molded article, process for production thereof composition;” EP 0 595 578, corresponding to U.S. Pat. No. 5,407,991 issued to Hikasa et al. on Apr. 18, 1995 and entitled “Thermoplastic elastomer composition, Covering materials for industrial parts comprising the composition and laminates comprising the covering materials;” U.S. Pat. No. 5,824,400 issued to Petrakis et al. on Oct. 20, 1998 and entitled “Plastic article and process for the preparation thereof;” and U.S. Pat. No. 3,616,020 issued to Whelan on Oct. 26, 1971 and entitled “Extrusion coating of a heated fusible foam sheet.”

The padding or covering of doors and, in conjunction with laminated textiles, the composite material in accordance with our invention can serve to replace other materials. Similarly, the material of the invention can be used for knee pillows or insulating mats.

Some examples of knee pillows in which the present invention may possibly be used or adapted for use and features of which may possibly be used or adapted for use in at least one possible embodiment of the invention may be found in the following U.S. Pat. No. 4,177,806 issued to Griffin on Dec. 11, 1979 and entitled “Knee pillow;” No. 4,736,477 issued to Moore on Apr. 12, 1988 and entitled “Knee pillow;” No. 4,889,109 issued to Gifford on Dec. 26, 1989 and entitled “Knee separation cushion;” No. 5,117,522 issued to Everett on Jun. 2, 1992 and entitled “Leg pillow;” No. 6,145,508 issued to Seip, Jr. on Nov. 14, 2000 and entitled “Comfort pillow;” and No. 6,438,779 issued to Brown on Aug. 27, 2002 and entitled “Knee pillow.” All of the foregoing U.S. patents are hereby incorporated by reference as if set forth in their entirety herein.

Some examples of insulating mats in which the present invention may possibly be used or adapted for use and features of which may possibly be used or adapted for use in at least one possible embodiment of the invention may be found in the following U.S. Pat. No. 4,533,583 issued to May on Aug. 6, 1985 and entitled “Thermal insulating mat;” No. 5,023,128 issued to Fatool on Jun. 11, 1991 and entitled “Impact-absorbing pad;” No. 5,024,289 issued to Merry on Jun. 18, 1991 and entitled “Insulated double-walled exhaust pipe;” No. 5,030,501 issued to Colvin et al. on Jul. 9, 1991 and entitled “Cushioning structure;” No. 5,056,564 issued to Roth on Oct. 15, 1991 and entitled “Insulating mat for bodies of which at least portions of the surface are curved, and in particular for pipes, and the use of such a mat;” and No. No. 5,250,269 issued to Langer on Oct. 5, 1993 and entitled “Catalytic converter having a metallic monolith mounted by a heat-insulating mat of refractory ceramic fibers.” All of the foregoing U.S. patents are hereby incorporated by reference as if set forth in their entirety herein.

The corresponding foreign and international patent publication applications, namely, Federal Republic of Germany Patent Application No. 101 05 591.9, filed on Feb. 6, 2001 having inventor Jürgen BRUNING, and Federal Republic of Germany Laid Open Patent Application No. 101 05 591, and Federal Republic of Germany Patent No. 101 05 591; and Federal Republic of Germany Patent Application No. 101 63 601.6; and Federal Republic of Germany Laid Open Patent Application No. 101 63 601, and Federal Republic of Germany Patent No. 101 63 601; and International Application No. PCT/EP02/01236, filed on Feb. 6, 2002, having WIPO Publication No. WO02/062571 and inventors Dag LANDVIK, Jürgen BRUNING, Eberhard LÖANG, Maik ZIEGLER, Peter NYSTRÖM, and Mats KARLSSON, as well as their published equivalents, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

Thermoforming of the composite material may be done as a matter of choice in a separate processing step. Thermoforming may comprise heating of the composite material that takes place outside of the tool or mold. Such heating facilitates homogeneous heating such that tempering of the resulting structure need not be done. With respect to timing, thermoforming may be done prior to joining to a further structure and/or workpiece such that the composite material practically cools again, so that it needs to be fully re-heated for welding or, respectively, laminating at the locations that are to be welded or laminated. In the event of short time intervals, the composite material still contains residual heat from thermoforming at the locations that are to be welded or, respectively, laminated, and the re-heating comprises a more or less low re-heating. The period of time may be utilized for a desired, as given by the circumstances, lowering of the temperature within the polypropylene (PP) foam in the composite material, so as to stabilize sensitive polypropylene (PP) foam types. The temperature limits can readily be determined by several experiments. In the case of re-heating, the temperature, at the locations that are to be welded or, respectively, laminated, may be raised for a short period of time without problems to above the thermoforming temperature, since the polypropylene (PP) foam has a low heat conductivity.

Thermoforming may be done in customary manner in a press between male and female die structures. Thermoforming may be done either alone or additionally with application of suction or vacuum and/or, at the opposite side, by the application of a sufficient pressure of air.

Some examples of thermoforming of a composite material comprising a skin and a foam backing, features of which may possibly be used or adapted for use in at least one possible embodiment of the present invention may be found in the following U.S. Pat. No. 4,440,703 issued to Akiyama et al. on Apr. 3, 1984 and entitled “Process for producing foamed and molded article of polypropylene resin;” No. 4,674,972 issued to Wagner on Jun. 23, 1987 and entitled “Apparatus for thermoforming plastic articles;” No. 4,692,111 issued to Wagner on Sep. 8, 1987 and entitled “Apparatus for forming plastic articles;” No. 5,093,967 issued to Frank on Mar. 10, 1992 and entitled “Attachment mechanism for nonwoven thermoformed articles and method of manufacture thereof;” No. 5,427,732 issued to Shuert on Jun. 27, 1995 and entitled “Method of forming deep draw twin sheet plastic articles;” and No. 5,795,535 issued to Giovannone et al. on Aug. 18, 1998 and entitled “Method of thermoforming plastic articles.” All of the foregoing U.S. patents are hereby incorporated by reference as if fully set forth in their entirety herein.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application, and also the patents in which they are in turn cited.

In further applications, joining of the cut material or blank to other structures and/or workpieces that are fully or partially complete, can be done. The term structures and/or workpiece is to be understood in the broad sense. These may possibly be parts that are straight and/or round and/or have corners. They may possibly comprise textiles or other film materials.

In one aspect, the composite material according to the invention can serve to configure furniture portions, such as, backrests and seats.

Some examples of backrests in which the present invention may possibly find application or which may be used or adapted for use in at least one possible embodiment of the present invention, may be found in the following U.S. Pat. No. 5,553,917 issued to Adat et al. on Sep. 10, 1996 and entitled “Adjustable backrest” No. 5,649,739 issued to Zapf on Jul. 22, 1997 and entitled “Backrest for a seat arrangement;” No. 5,882,071 issued to Föhl on Mar. 16, 1999 and entitled “Vehicle seat with headrest adjustable on the backrest;” No. 5,975,632 issued to Ginat on Nov. 2, 1999 and entitled “Chair having a backrest with an adjustable contour;” No. 6,375,264 issued to Kienzle et al. on Apr. 23, 2002 and entitled “Backrest for a vehicle;” and No. 6,568,761 issued to Perske et al. on May 27, 2003 and entitled “Backrest of a motor vehicle seat.” All of the foregoing U.S. patents are hereby incorporated by reference as if set forth in their entirety herein.

Some examples of seats in which the present invention may possibly find application or which may be used or adapted for use in at least one possible embodiment of the present invention, may be found in the following U.S. Pat. No. 6,502,902 issued to Romero on Jan. 7, 2003 and entitled “Stadium seat;” No. 6,546,578 issued to Steinmeier on Apr. 15, 2003 and entitled “Seat cushion for vehicle seats;” No. 6,565,157 issued to Barile, Jr. et al. on May 20, 2003 and entitled “Molded foam spring seat;” No. 6,571,411 issued to Ebe on Jun. 3, 2003 and entitled “Seat cushion and method of manufacturing the same;” No. 6,585,318 issued to Tak on Jul. 1, 2003 and entitled “Safety seat;” and No. 6,588,840 issued to Lombardo on Jul. 8, 2003 and entitled “Seat cushion for stadium seats.” All of the foregoing U.S. patents are hereby incorporated by reference as if set forth in their entirety herein.

The details in the patents, patent applications and publications may be considered to be incorporable, at Applicants' option, into the claims during prosecution as further limitations in the claims to patentably distinguish any amended claims from any applied prior art.

The polypropylene (PP) cover layer described in the foregoing, as a rule, remains as the outer portion and in combination with other structures and/or workpieces. There the cover layer is then to fashion the upper or viewable surface. The polypropylene (PP) foam layer is then positioned inwardly as foam backing. Various joining techniques are suitable for joining, for example, gluing or adhesion and welding.

The further structures and/or workpieces, with which a combination is desired, may be non-foamed or foamed plastics. Many materials do not pose a problem with gluing. Joining to other structures and/or workpieces can be made by way of welding or laminating. The joining by welding and laminating to a further structure and/or workpiece makes sufficient heating of the contact surfaces a prerequisite, as has been described in the foregoing with respect to laminating and welding.

Some examples of laminating and welding, features of which may possibly be used or adapted for use with at least one embodiment of the present invention may be found in the following U.S. Pat. No. 4,163,080 issued to Buzio et al. on Jul. 31, 1979 and entitled “Flexible double-layer polypropylene laminates for the packaging of food products;” No. 4,259,412 issued to Buzio et al. on Mar. 31, 1981 and entitled “Flexible double-layer polypropylene laminates;” No. 4,505,969 issued to Weiner on Mar. 19, 1985 and entitled “Oriented polypropylene with linear low density poly-ethylene copolymer coatings;” No. 5,837,369 issued to Grünberger et al. on Nov. 17, 1998 and entitled “Multilayer polypropylene-based packaging film and its use;” and No. 6,251,319 issued to Tusim et al., on Jun. 26, 2001 and entitled Method of forming a thermoformable polypropylene foam sheet.” All of the foregoing U.S. patents are hereby incorporated by reference as if set forth in their entirety herein.

In accordance with one aspect the invention is concerned with a motor vehicle dashboard for a motor vehicle. The motor vehicle dashboard has a frame structure that can be attached to a motor vehicle body. The dashboard has a first element with a first attachment side and a second attachment side opposite the first attachment side, with the first attachment side of the first element being configured to be adhered to the frame structure. The first element comprises foam. The dashboard has a second element with a first side that is configured to be exposed towards the interior of a motor vehicle, and a second, attachment, side opposite the first side of the second element. The first side of the second element provides a leather-like appearance to the dashboard.

The abstract of the disclosure is submitted herewith as required by 37 C.F.R. §1.72(b). As stated in 37 C.F.R. §1.72(b):

A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, the abstract is not intended to limit the claims in any manner and should not be interpreted as limiting the claims in any manner.

Some further examples of foam welding, features of which may possibly be used or adapted for use with at least one embodiment of the present invention may be found in the following U.S. Pat. No. 4,524,096 issued to Schiedegger et al. on Jun. 18, 1985 and entitled “Heat bonded composite plastic article and method and apparatus for making same;” No. 4,770,730 issued to Abe on Sep. 13, 1988 and entitled “Ultrasonic welding method for soft elastic foam body;” No. 5,460,871 issued to Andersen on Oct. 24, 1995 and entitled “Multilayer sheet material and articles formed therefrom;” No. 5,916,672 issued to Reeves et al. on Jun. 29, 1999 and entitled “Thermoplastic multi-layer composite structure;” No. 6,444,073 issued to Reeves et al. on Sep. 3, 2002 and entitled “Thermoplastic multi-layer composite structure;” and No. 6,471,908 issued to Beckmann on Oct. 29, 2002 and entitled “Method for the fabrication of synthetic-material component assemblies.” All of the foregoing U.S. patents are hereby incorporated by reference as if set forth in their entirety herein.

Some examples of adhesively joining layers of material, features of which may possibly be used or adapted for use with at least one embodiment of the present invention may be found in the following U.S. Pat. No. 4,559,094 issued to Hostetler et al. on Dec. 17, 1985 and entitled “Process for forming cushion articles;” No. 4,692,199 issued to Kozlowski et al. on Sep. 8, 1987 and entitled “Method and apparatus for bonding fabric to a foam pad;” No. 4,740,260 issued to Selbert et al. on Apr. 26, 1988 and entitled “Method and apparatus for manufacturing seats and article formed thereby;” No. 5,000,805 issued to Lowe on Mar. 19, 1991 and entitled “Method for vacuum forming composite vehicle seat;” No. 5,254,197 issued to Klems on Oct. 19, 1993 ands entitled “Microwave bonding of foam to fabric using water as a susceptor;” and No. 5,294,386 issued to Roth et al. on Mar. 15, 1994 and entitled “Process for the production of padding of polyurethane foam cast in situ in a textile covering.” All of the foregoing U.S. patents are hereby incorporated by reference as if set forth in their entirety herein.

Some examples of automotive trim in which the present invention may possibly find application or which may be used or adapted for use in at least one possible embodiment of the present invention, may be found in the following U.S. Pat. No. 3,149,018 issued to Jacobson on Sep. 15, 1964 and entitled “Film-covered article and method of making same;” No. 3,580,770 issued to Dyal on May 25, 1971 and entitled “Method for producing laminated structures;” No. No. 6,085,483 issued to Kurosaki on Jul. 11, 2000 and entitled “Trim assembly for vehicle and method for manufacturing the same;” and No. 6,177,155 issued to Kurosaki on Jan. 23, 2001 and entitled “Trim assembly for vehicle and method for manufacturing the same.” All of the foregoing U.S. patents are hereby incorporated by reference as if set forth in their entirety herein.

During deep-drawing or, respectively, thermoforming a more or less penetrating heating of the composite material to the shaping temperature takes place. In simultaneous thermoforming of the composite material and its joining to a further structure and/or workpiece it may be of advantage, due to the differing requirements made of heating for thermoforming, on the one hand, and the heating for laminating, on the other hand, to carry out the penetrating heating of material for the deep-drawing step at a markedly lower temperature level than the heating for laminating. The temperature may be, for example, 20 degrees Celsius, and more, below the laminating temperature described in the foregoing. The correct temperature can be readily determined by several experiments. It is surprising that the heat-treated foam of the composite material does not collapse.

The heat that is required for thermoforming and/or deep-drawing is preferably applied on both sides of the composite material. The composite material may also be heated outside of the deep-drawing equipment and/or within the deep-drawing equipment. When heating outside of the deep-drawing equipment takes place, the heating device may be stationary. When heating within the deep-drawing mold takes place, there are preferably used movable heating devices that can be moved into the open mold.

Some examples of deep-drawing, features of which may possible be used or adapted for use in at least one possible embodiment of the present invention may be found in the following U.S. Pat. No. 4,073,857 issued to Arakawa on Feb. 14, 1978 and entitled “Deep-drawing of a monoaxially oriented, heat relaxed polyester film;” No. 4,261,775 issued to Tschudin on Apr. 14, 1981 and entitled “Method of deep-drawing of foam material-mold parts;” No. 4,877,571 issued to Reifenhäuser on Oct. 31, 1989 and entitled “Process for deep drawing composite thermoplastic foil with a PVDC layer;” No. 5,080,853 issued to Hexel on Jan. 14, 1992 and entitled “Process for deep drawing plastic foils;” No. 5,230,910 issued to Eggert on Jul. 27, 1993 and entitled “Apparatus for the cold deep drawing of films;” and No. 6,339,949 issued to Takamatu on Jan. 22, 2002 and entitled “Deep drawing method.” All of the foregoing U.S. Patents are hereby incorporated by reference as if set forth in their entirety herein.

It will be understood that the examples of patents, published patent applications, and other documents which are included in this application and which are referred to in paragraphs which state “Some examples of . . . which may possibly be used in at least one possible embodiment of the present invention . . . ” may possibly not be used or useable in any one or more embodiment of the invention.

The sentence immediately above relates to patents, published patent applications and other documents either incorporated by reference or not incorporated by reference.

For example, evacuation may be facilitated by a suitable roughness of the upper surface and/or fine porosity and/or the structure and/or workpiece is fully or partially air-permeable. It is surprising that a structure is sufficiently air-permeable even when it comprises particle foam. Particle foam comprises small foam particles with a diameter of, for example, from about 0.5 to about 15 millimeters. It will be appreciated that the stated range of from about 0.5 to about 15 millimeters includes that values of the limits of the stated range, values such as 0.6 millimeters, 0.7 millimeters and so forth, and may possibly comprise values that are outside of the stated range.

The above described automatic molding machines include selectable shaping tools that are configured in such a way that the female die structure corresponds to the outer contour of the product that is to be manufactured, comprises a porous material or is perforated. Use can be made hereby of porous resins, sintered metals, lattice structures, tools that have been subsequently perforated or tool inserts. The production of the tool halves can be done by producing a mother model and by molding with a porous or pore-forming resin or by means of milling of porous semifinished products, for example, made of resin or sintered metal. Structuring of the upper surface of the tool or of portions thereof is selectively done by etching of the tool or the upper surface of the mother model. Structuring of the upper surface of the mother mold may also be achieved by a lacquer that produces a structuring.

Some examples of molds and slides for molds that may possibly be used or adapted for use to mold composite materials in accordance with the present invention or features of which may possibly be used or adapted for use in at least one possible embodiment of the present invention, may be found in the following U.S. Pat. No. 4,832,307 issued to Watanabe et al. on May 23, 1989 and entitled “Injection mold;” No. 4,875,843 issued to Onnenberg et al. on Oct. 24, 1989 and entitled “Vacuum mold for manufacturing cushions with back-foamed covers;” No. 5,595,771 issued to Foltuz et al. on Jan. 21, 1997 and entitled “Modular mold for injection molding and method of use thereof;” No. 6,287,106 issued to Learn et al. on Sep. 11, 2001 and entitled “Injection mold cavity and dispensing cap manufactured therein;” No. 6,443,723 issued to Buttigieg on Sep. 3, 2002 and entitled “Slide retainer for an injection mold;” and No. 6,450,797 issued to Joseph on Sep. 17, 2002 and entitled “Compact slide actuation mold.” All of the foregoing U.S. Patents are hereby incorporated by reference as if set forth in their entirety herein.

The following references, commonly owned and relating to plastic molding methods and plastic molding apparatus, are hereby incorporated by reference as if set forth in their entirety herein: U.S. Pat. No. 6,074,084 issued to Kolossow on Jun. 13, 2000, having Attorney Docket No. NHL-KK-09 and entitled “Extruder for plastics;” U.S. patent application Ser. No. 09/933,257 filed on Aug. 20, 2001, and entitled “Method for producing a product comprising plastic foam in an automatic molding machine; moulded-part machine for producing plastic foam products from beads,” having Attorney Docket No. NHL-KK-36 and inventors Jürgen BRUNING and Eberhard LANG; and proposed U.S. patent application Ser. No. having Attorney Docket No. KK-41-NP having inventor Jürgen BRUNING and having the title “Plastic foam products consisting of beads.”

Some examples of porous molds which may be used or adapted for use in at least one possible embodiment molding in accordance with the present invention, or features of which may possibly be used or adapted for use in at least one possible embodiment of the present invention may be found in the following U.S. Pat. No. 4,085,177 issued to Sauer on Apr. 18, 1978 and entitled “Process for thermoforming a hollow plastic article using an extendible porous male mold assembly;” No. 4,174,364 issued to Balosetti on Nov. 13, 1979 and entitled “Process for manufacture of porous metal objects and use of the process for manufacture of a porous mold;” No. 5,281,383 issued to Ueki et al. on Jan. 25, 1994 and entitled “Method for molding a laminated molded article using a vented mold;” No. 5,678,162 issued to Barlow et al. on Oct. 14, 1997 and entitled “Mold useful for injection molding of plastics, and methods of production and uses thereof;” No. 6,302,671 issued to Gilfert et al. on Oct. 16, 2001 and entitled “Porous mold for a roll support and spacing structure;” and No. 6,514,454 issued to Ganguli et al. on Feb. 4, 2003 and entitled “Sol-gel process using porous mold.” All of the foregoing U.S. patents are hereby incorporated by reference as if set forth in their entirety herein.

The invention as described herein above in the context of the preferred embodiments is not to be taken as limited to all of the provided details thereof, since modifications and variations thereof may be made without departing from the spirit and scope of the invention.

What is claimed is:

1. A motor vehicle dashboard for a motor vehicle, said motor vehicle dashboard comprising:
a frame structure, said frame structure being configured to be attached to a motor vehicle body;
a first element;
said first element comprising a first attachment side and a second attachment side opposite said first attachment side;
said first attachment side of said first element being configured to be adhered to said frame structure of said motor vehicle dashboard;
said first element comprising a first, non-crosslinked, foam, material;
a second element;
said second element comprising a first side being configured to be exposed towards the interior of a motor vehicle, and a second, attachment, side opposite said first side of said second element;
said second element comprising a second material different from said first material of said first element;
said second, attachment, side of said second element being adhered to said second attachment side of said first element;
said first material and said second material forming a composite material;
said first attachment side of said first element adhering to said frame structure of said motor vehicle dashboard; and
at least a portion of said first side of said second element being configured to be exposed towards the interior of a motor vehicle.

2. The dashboard according to claim 1, wherein said first, foam, material comprises a one-piece, foam, material.

3. The dashboard according to claim 2, including at least one of: (a), (b), and (c), wherein (a), (b), and (c) comprise:
(a) said first element and said second element are adhered to one another by at least one of: welding and adhesion,
(b) at least one of: said first, foam, material, and said second material, comprises greater than about 5% solid by weight, and
(c) said second material comprises at least one of: a textile material, a woven material, and a fleece material.

4. A structure comprising a foam material, said structure comprising, such as, one of: a motor vehicle dashboard, an instrument panel for a motor vehicle, an instrument panel structure for a motor vehicle, a bolster component for a motor vehicle, a body side molding for a motor vehicle, a trim portion for a motor vehicle, an armrest for a motor vehicle, a covered component for a motor vehicle, a covering for a door of a motor vehicle, a covering for an A-pillar, or a B-pillar, or a C-pillar for a motor vehicle, a protective strip for a motor vehicle, a sun visor for a motor vehicle, a covering for a door, a seat for a child, a pouch, a bag, a case, a case for a pair of glasses, a protective covering structure for an in-floor heating system, a knee pillow configured to protect knees against hard surfaces, and an insulating mat configured to insulate heated surfaces;
said structure comprising:
a support member;
a first element;
said first element comprising a first attachment side and a second attachment side opposite said first attachment side;
said first attachment side of said first element being configured to be adhered to said support member;
said first element comprising a first, non-crosslinked, foam, material;
a second element;
said second element comprising a first side being configured to be exposed, and a second, attachment, side opposite said first side of said second element;
said second element comprising a second material different from said first material of said first element;
said second, attachment, side of said second element being adhered to said second attachment side of said first element;
said first material and said second material forming a composite material; and
said first attachment side of said first element adhering to said support member.

5. The structure according to claim 4, wherein said first, foam, material comprises a one-piece, foam, material.

6. The structure according to claim 5, including at least one of: (a), (b), and (c), wherein (a), (b), and (c) comprise:
(a) said first element and said second element are adhered to one another by at least one of: welding and adhesion,
(b) at least one of: said first, foam, material, and said second material, comprises greater than about 5% solid by weight, and
(c) said second material comprises at least one of: a textile material, a woven material, and a fleece material.

7. A method of making a structure comprising a foam material, said structure comprising, such as, one of: a motor vehicle dashboard, an instrument panel for a motor vehicle, an instrument panel structure for a motor vehicle, a bolster component for a motor vehicle, a body side molding for a motor vehicle, a trim portion for a motor vehicle, an armrest for a motor vehicle, a covered component for a motor vehicle, a covering for a door of a motor vehicle, a covering for an A-pillar, or a B-pillar, or a C-pillar for a motor vehicle, a protective strip for a motor vehicle, a sun visor for a motor vehicle, a covering for a door, a seat for a child, a pouch, a bag, a case, a case for a pair of glasses, a protective covering structure for an in-floor heating system, a knee pillow configured to protect knees against hard surfaces, and an insulating mat configured to insulate heated surfaces;
said structure comprising:
a support member;
a first element;
said first element comprising a first attachment side and a second attachment side opposite said first attachment side;
said first attachment side of said first element being configured to be adhered to said support member;
said first element comprising a first, non-crosslinked, foam, material;
a second element;
said second element comprising a first side being configured to be exposed, and a second, attachment, side opposite said first side of said second element;
said second element comprising a second material different from said first material of said first element;
said second, attachment, side of said second element being adhered to said second attachment side of said first element;
said first material and said second material forming a composite material; and
said first attachment side of said first element adhering to said support member;
said method comprising the steps of:
forming said first element of said first, non-crosslinked foam, material, said forming of said first element comprising forming said first element with said first attachment side and said second attachment side opposite said first attachment side of said first element;
forming said second element of said second material, said forming of said second element comprising forming of said first side and said second, attachment, side opposite said first side of said second element;
adhering said first element with said second attachment side of said first element to said second, attachment, side of said second element and forming said composite material;
forming said composite material into a predetermined shape;
providing said support member; and
adhering said first attachment side of said first element to said support member.

8. The method of making a structure according to claim 7, wherein:
said forming of said composite material into a predetermined shape comprises heating and shaping of said composite material.

9. The method of making a structure according to claim 8, wherein said heating and shaping of said composite material comprises embossing said first side of said second element to provide the appearance of leather to said first side of said second element.

10. The method of making a structure according to claim 7, wherein:
said forming of said composite material into a predetermined shape further comprises molding of said composite material in a mold.

11. The method of making a structure according to claim 10, wherein:
said molding comprises shaping at least a portion of said second element into a bent portion.

12. The method of making a structure according to claim 7, wherein:
said first element comprises an extruded, non-crosslinked, polypropylene, foam having a melt strength of at least 5 centi-Newtons, at a temperature of 200 degrees Celsius, at an output of 1 cubic centimeter per minute, while pressing a polypropylene melt from a container into a nozzle that has an opening width of 1 millimeter and a length of 20 millimeters, grasping and removing a polypropylene melt strand with increasing acceleration from the nozzle while measuring the tensile force until tearing off the strand of polypropylene;
said second element comprises at least one of: polypropylene, a thermoplastic polyolefin, a textile material, a woven material, and a fleece material;
said second element having a weight of at least 120 grams per square meter; and
said method further comprising at least one of: (a) and (b), wherein (a) and (b) comprise:
(a) laminating said first element and second element to one another, and
(b) welding said first element and said second element to one another.

13. The method of making a structure according to claim 12, wherein:
at least one of: said first element and said second element comprises greater than about 5% solid by weight.

14. The method of making a structure according to claim 13, including one of: (a), (b), and (c), wherein (a), (b), and (c) comprise:
(a) said extruded, non-crosslinked, polypropylene, foam comprises at least one of: (i.), (ii.), and (iii.), wherein (i.), (ii.), and (iii.) comprise:
(i.) high melt strength polypropylene,
(ii.) a mixture of polypropylene copolymer and polypropylene homopolymer, said mixture comprising polypropylene in the range of from about 5% to about 70% by weight based on the total amount of plastic, and
(iii.) substantially only polypropylene homopolymer;
(b) said extruded, non-crosslinked, polypropylene, foam comprises foam having at least one of: (i.), (ii.), (iii.), (iv.), (v.), and (vi.), wherein (i.), (ii.), (iii.), (iv.), (v.), and (vi.) comprise:
(i.) a cell size of from about 0.4 to about 4 millimeters,
(ii.) a cell size of from about 0.5 to about 1.5 millimeters,
(iii.) a thickness of from about 0.5 to about 10 millimeters,
(iv.) a thickness of from about 2 to about 4 millimeters,
(v.) a specific gravity of from about 20 to about 400 kilograms per cubic meter, and
(vi.) a specific gravity of from about 30 to about 150 per cubic meter; and
(c) said polypropylene foam comprises an extruded, one-piece, foam having a predetermined thickness.

15. The method of making a structure according to claim 14, including at least one of: (a), (b), (c), (d), (e), (f), (g), (h), (i), (j), (k), (l), (m), (n), (o), (p), (q), (r), and (s), wherein (a), (b), (c), (d), (e), (f), (g), (h), (i), (j), (k), (l), (m), (n), (o), (p), (q), (r), and (s) comprise:
(a) said composite material comprises at least one mixture of materials, said at least one mixture of materials comprising a predetermined amount of plastic material and a predetermined amount of non-plastic, filler, material;
(b) said composite material has a resistance to remelting at a temperature of from about 155 to about 165 degrees Celsius;
(c) joining said second attachment side of said first element and said second, attachment, side of said second element of said composite material to one another upon heating to a temperature that is at most about 20 degrees Celsius below the melting temperature of said composite material to effectuate one of: laminating and welding;
(d) applying said extruded, non-crosslinked, polypropylene, foam directly as a foam onto said second element of said composite material;
(e) extruding said second element onto said extruded, non-crosslinked, polypropylene, foam;
(f) said first element has a melting point of one of: (i) and (ii.), wherein (i) and (ii.) comprise:
(i) greater than about 155 degrees Celsius, and
(ii) greater than about 165 degrees Celsius, and
said second element of said composite material has a heat resistance of from about 140 to about 180 degrees Celsius.
(g) moving said first element against a heated second element by one of: prior to calendering and after calendering;
(h) adhering said composite material to said support member by one of: molding, laminating, and welding;
(i) one of: (1) and (2), wherein (1) and (2) comprise:
(1) heating and shaping said composite material prior to adhering said composite material to said support member, and
(2) heating and shaping said composite material while adhering said composite material to said support member;
(j) heating and shaping said composite material in a mold that is subjected to at least one of: a positive pressure and a negative pressure;
(k) heating said composite material to one of: (i), (ii.), and (iii), wherein (i), (ii), and (iii) comprise:
(i) the shaping temperature of said composite material,
(ii) the welding temperature of said composite material, and
(iii) the laminating temperature of said composite material;
said heating comprising one of: (1) and (2), wherein (1) and (2) comprise:
(1) heating said composite material in a furnace within the corresponding mold, and
(2) heating said composite material in a furnace exteriorly of the corresponding mold;
(l) heating and shaping said composite material; and
further heating said composite material to one of: (1) and (2), wherein (1) and (2) comprise:
(1) the welding temperature of said composite material, and
(2) the laminating temperature of said composite material,
said further heating comprising using heat generated during said heating and shaping of said composite material;
(m) pressing said composite material against said support member in a mold configured to heat and shape said composite material to effectuate at least partial contact between said composite material and said support member; and
heating and shaping said composite material;
(n) at least one of: said composite material and said frame structure, comprises one of: an air conducting surface and an air-permeable surface;
(o) said composite material comprises an air-permeable, particle-foam, structural molded part;
(p) one of: (i) and (ii), wherein (i) and (ii) comprise:
(i) positioning said composite material in an automatic molding machine having a mold cavity,
filling said mold cavity with foam particles, and steaming said foam particles and welding said foam particles to one another and to said composite material by steaming; and
(ii) positioning said composite material in an injection molding mold having a mold cavity, and
injecting one of: (1) and (2), wherein (1) and (2) comprise:
(1) molten plastic capable of welding to said composite material, and
(2) a melt, containing a foaming agent, capable of welding to said composite material into the mold cavity;
(q) said composite material comprises weldment locations, and further comprising the step of preheating of the weldment locations at the composite material to effectuate joining to said support member;
(r) heating and shaping said composite material to effectuate embossing of said first side of said second element to provide the appearance of leather, said heating comprising heating said composite material to the embossing temperature of said composite material; and
(s) one of: (1) and (2), wherein (1) and (2) comprise:
(1) adhering said composite material to said support member, and
(2) heating and shaping of said composite material,
are effectuated in a mold, said mold comprising at least one of: (i), (ii), (iii), (iv), (v), and (vi), wherein (i), (ii), (iii), (iv), (v), and (vi) comprise:
(i) a porous mold,
(ii) a mold with perforations,
(iii) a mold made of at least one of: a porous resin, a pore-resin, a metal, and a sintered metal,
(iv) a mold manufactured from one of: (a) and (b), wherein (a) and (b) comprise:
(a) a mother mold, and
(b) a semifinished mold body that is shaped by removal of material to configure a fully finished mold body,
(v) a mold in which said composite material is held by one of: (a) and (b), wherein (a) and (b) comprise:
(a) a sleeve-type structure having inner dimensions that correspond to the outer dimensions of said composite material, and
(b) a spectacle-type structure having inner dimensions that correspond to the outer dimensions of said composite material,
(vi) a divisible mold with one of: (a) and (b), wherein (a) and (b) comprise:
(a) a sleeve-type structure arranged in the separating region of the divisible mold and at the mold component that is located at the viewable side of said composite material, and
(b) a spectacle-type structure arranged in the separating region of the divisible mold and at the mold component that is located at the viewable side of said composite material.

16. The method of making a structure according to claim 15, and comprising:
foaming said first element with a foaming agent;
said foaming agent having a hydrocarbon content that is one of:
about 50% by weight in relation to the total amount of foaming agent and more than about 90% by weight in relation to the total amount of foaming agent.

17. The method of making a structure according to claim 16, wherein:
said foaming agent comprises a foaming gas;
said foaming gas comprises an inert gas;
said inert gas having a content of up to 25% by weight in relation to the total amount of foaming gas;
said foaming gas comprising at least one of: carbon dioxide and nitrogen.

18. The method of making a structure according to claim 17, and further comprising:
forming at least one of: (i) and (ii), wherein (i) and (ii) comprise:
(i) molding said second element with at least one bent portion that projects away from said first element in the corresponding mold, and
(ii) forming said composite material with least one bent portion that projects away from said support member.

19. The method of making a structure according to claim 18, and further comprising:
forming, with slides, at least one bent portion.

20. The method of making a structure according to claim 7, comprising all of (a), (b), (c), (d), (e), (f), (g), (h), (i), (j), (k), (l), (m), (n), (o), (p), (q), and (r), wherein (a), (b), (c), (d), (e), (f), (g), (h), (i), (j), (k), (l), (m), (n), (o), (p), (q), and (r) comprise:
(a) said forming of said composite material into a predetermined shape comprises heating and shaping of said composite material;
(b) said heating and shaping of said composite material comprises embossing said first side of said second element to provide the appearance of leather to said first side of said second element;
(c) said forming of said composite material into a predetermined shape further comprises molding of said composite material in a mold;
(d) said molding comprises shaping at least a portion of said second element into a bent portion;
(e) said first element comprises an extruded, non-crosslinked, polypropylene, foam having a melt strength of at least 5 centi-Newtons, at a temperature of 200 degrees Celsius, at an output of 1 cubic centimeter per minute, while pressing a polypropylene melt from a container into a nozzle that has an opening width of 1 millimeter and a length of 20 millimeters, grasping and removing a polypropylene melt strand with increasing acceleration from the nozzle while measuring the tensile force until tearing off the strand of polypropylene;
(f) said second element comprises at least one of:
polypropylene, a thermoplastic polyolefin, a textile material, a woven material, and a fleece material;
(g) said second element having a weight of at least 120 grams per square meter;
(h) at least one of: said first element and said second element comprises greater than about 5% solid by weight;
(i) said first element comprises at least one of: (i), (ii), and (iii), wherein (i), (ii), and (iii) comprise:
(i) high melt strength polypropylene,
(ii) a mixture of polypropylene copolymer and polypropylene homopolymer, said mixture comprising polypropylene in the range of from about 5% to about 70% by weight based on the total amount of plastic, and
(iii) substantially only polypropylene homopolymer;
(j) said first element has at least one of: (i), (ii), (iii), (iv), (v), (vi), an (vii), wherein (i), (ii), (iii), (iv), (v), (vi), and (vii) comprise:
(i) a cell size of from about 0.4 to about 4 millimeters,
(ii) a cell size of from about 0.5 to about 1.5 millimeters,
(iii) a thickness of from about 0.5 to about 10 millimeters,
(iv) a thickness of from about 2 to about 4 millimeters,
(v) a specific gravity of from about 20 to about 400 kilograms per cubic meter, and
(vi) a specific gravity of from about 30 to about 150 per cubic meter, and
(vii) a melting point of one of: (1) and (2), wherein (1) and (2) comprise:
(1) greater than about 155 degrees Celsius, and
(2) greater than about 165 degrees Celsius;
(k) said second element of said composite material has a heat resistance of from about 140 to about 180 degrees Celsius;
(l) said first element comprises an extruded, one-piece, foam having a predetermined thickness;
(m) said composite material has a resistance to remelting at a temperature of from about 155 to about 165 degrees Celsius;
(n) one of: (1), (2), (3), (4), (5), (6), (7), (8), (9), (10), (11), (12), (13), (14), and (15), wherein (1), (2), (3), (4), (5), (6), (7), (8), (9), (10), (11), (12), (13), (14), and (15) comprise:
(1) joining said second attachment side of said first element and said second, attachment, side of said second element of said composite material to one another upon heating to a temperature that is at most about 20 degrees Celsius below the melting temperature of said composite material to effectuate one of: laminating and welding,
(2) applying said first element directly as a foam onto said second element of said composite material,
(3) extruding said second element onto said first element,
(4) moving said first element against a heated second element by one of: prior to calendering and after calendering,
(5) adhering said composite material to said support member by one of: molding, laminating, and welding,
(6) one of: (a) and (b), wherein (a) and (b) comprise:
(a) heating and shaping said composite material prior to adhering said composite material to said support member, and
(b) heating and shaping said composite material while adhering said composite material to said support member,
(7) heating and shaping said composite material in a mold that is subjected to at least one of: a positive pressure and a negative pressure;
(8) heating said composite material to one of: (i), (ii.), and (iii), wherein (i), (ii), and (iii) comprise:
(i) the shaping temperature of said composite material,
(ii) the welding temperature of said composite material, and
(iii) the laminating temperature of said composite material,
said heating comprising one of: (1) and (2), wherein (1) and (2) comprise:
(1) heating said composite material in a furnace within the corresponding mold, and
(2) heating said composite material in a furnace exteriorly of the corresponding mold,
(9) heating and shaping said composite material, and further heating said composite material to one of: (1) and (2), wherein (1) and (2) comprise:
(1) the welding temperature of said composite material, and
(2) the laminating temperature of said composite material,
said further heating comprising using heat generated during said heating and shaping of said composite material,
(10) pressing said composite material against said support member in a mold configured to heat and shape said composite material to effectuate at least partial contact between said composite material and said support member, and
heating and shaping said composite material,
(11) at least one of: said composite material and said frame structure, comprises one of: an air conducting surface and an air-permeable surface,
(12) one of: (i) and (ii), wherein (i) and (ii) comprise:
(i) positioning said composite material in an automatic molding machine having a mold cavity,
filling said mold cavity with foam particles, and steaming said foam particles and welding said foam particles to one another and to said composite material by steaming, and
(ii) positioning said composite material in an injection molding mold having a mold cavity, and
injecting one of: (1) and (2), wherein (1) and (2) comprise:
(1) molten plastic capable of welding to said composite material, and
(2) a melt, containing a foaming agent, capable of welding to said composite material into the mold cavity,
(13) said composite material comprises weldment locations, and further comprising the step of preheating of the weldment locations at the composite material to effectuate joining to said support member,
(14) heating and shaping said composite material to effectuate embossing of said first side of said second element to provide the appearance of leather, said heating comprising heating said composite material to the embossing temperature of said composite material, and
(15) one of: (1) and (2), wherein (1) and (2) comprise:
(1) adhering said composite material to said support member, and
(2) heating and shaping said composite material, are effectuated in a mold, said mold comprising at least one of: (i), (ii), (iii), (iv), (v), and (vi), wherein (i), (ii), (iii), (iv), (v), and (vi) comprise:
(i) a porous mold,
(ii) a mold with perforations,
(iii) a mold made of at least one of: a porous resin, a pore-resin, a metal, and a sintered metal,
(iv) a mold manufactured from one of: (a) and (b), wherein (a) and (b) comprise:
(a) a mother mold, and
(b) a semifinished mold body that is shaped by removal of material to configure a fully finished mold body,
(v) a mold in which said composite material is held by one of: (a) and (b), wherein (a) and (b) comprise:
(a) a sleeve-type structure having inner dimensions that correspond to the outer dimensions of said composite material, and
(b) a spectacle-type structure having inner dimensions that correspond to the outer dimensions of said composite material,
(vi) a divisible mold with one of: (a) and (b), wherein (a) and (b) comprise:
(a) a sleeve-type structure arranged in the separating region of the divisible mold and at the mold component that is located at the viewable side of said composite material, and
(b) a spectacle-type structure arranged in the separating region of the divisible mold and at the mold component that is located at the viewable side of said composite material;
(o) foaming said first element with a foaming agent;
said foaming agent having a hydrocarbon content that is one of:
about 50% by weight in relation to the total amount of foaming agent and more than about 90% by weight in relation to the total amount of foaming agent;
(p) said foaming agent comprises a foaming gas,
said foaming gas comprises an inert gas,
said inert gas having a content of up to 25% by weight in relation to the total amount of foaming gas,
said foaming gas comprising at least one of: carbon dioxide and nitrogen.
(q) forming at least one of: (i) and (ii), wherein (i) and (ii) comprise:
(i) molding said second element with at least one bent portion that projects away from said first element in the corresponding mold, and
(ii) forming said composite material with least one bent portion that projects away from said support member; and
(r) forming, with slides, said at least one bent portion.
